(19) United States
(12) Patent Application Publication
(10) Pub. No.: US 2011/0063440 A1
(43) Pub. Date: Mar. 17, 2011

(54) TIME SHIFTED VIDEO COMMUNICATIONS

(76) Inventors: Carman G. Neustaedter, Webster, NY (US); Tejinder K. Judge, Blacksburg, VA (US); Andrew F. Kurtz, Macedon, NY (US); Elena A. Fedorovskaya, Pittsford, NY (US)

(21) Appl. No.: 12/557,709

(22) Filed: Sep. 11, 2009

(51) Int. Cl. H04N 7/18

(52) U.S. Cl. 348/143; 348/E07.085

(57) ABSTRACT

A method for providing video images to a remote viewer using a video communication system, comprising: operating a a video communication client in a local environment connected by a communications network to a remote viewing client in a remote viewing environment; capturing video images of the local environment; analyzing the captured video images with the video analysis component to detect ongoing activity within the local environment; characterizing the detected activity within the video images with respect to attributes indicative of remote viewer interest; determining whether acceptable video images are available; receiving an indication of whether the remote viewing client is engaged or disengaged; and transmitting the acceptable video images of the ongoing activity to the remote viewing client if the remote viewing client is engaged, or alternately, if the remote viewing client is disengaged, recording the acceptable video images into a memory.

### CROSS REFERENCE TO RELATED APPLICATIONS

Reference is made to commonly-assigned co-pending U.S. patent application Ser. No. 11/756,532, filed May 31, 2007, entitled “A Residual Video Communication System” by Kurtz, et al., to commonly-assigned co-pending U.S. patent application Ser. No. 12/406,186, filed Mar. 18, 2009, entitled “Detection of Animate or Inanimate Objects” by P. Fry et al., to commonly-assigned co-pending U.S. patent application Ser. No. 12/408,898, filed Mar. 23, 2009, entitled “Automated Videography System” by Kurtz et al., and to commonly-assigned co-pending U.S. patent application Ser. No. 12/411,431, filed Mar. 20, 2009, entitled “Automated Videography Based Communications” by Kurtz, et al., the disclosures of which are incorporated herein by reference.

### FIELD OF THE INVENTION

The present invention relates to a video communication system providing a real time video communication link between two or more locations, and more particularly to an automated method for detecting and characterizing activity in a local environment, and then transmitting or recording video images, for either live or time shifted viewing in a remote location, respectively, depending on both the acceptability of the characterized images and the status of users at the remote viewing system.

### BACKGROUND OF THE INVENTION

At present, video communications remains an emergent field, with various examples, including webcams, cell phones, and teleconferencing or telepresence systems providing partial solutions or niche market solutions.

The first working videophone system was exhibited by Bell Labs at the 1964 New York World's Fair. AT&T subsequently commercialized this system in various forms, under the Picturephone brand name. However, the Picturephone had very limited commercial success. Technical issues, including low resolution, lack of color imaging, and poor audio-to-video synchronization affected the performance and limited the appeal. Additionally, the Picturephone imaged a very restricted field of view, basically amounting to a portrait format image of a participant. This can be better understood from U.S. Pat. No. 3,495,908, by W. Rea, which describes a means for aligning a user within the limited capture field of view of the Picturephone camera. Thus, the images were captured with little or no background information, resulting in a loss of context. Moreover, the Picturephone's only accommodation to maintaining the user's privacy was the option of turning off the video transmission.

As a lesser known alternative, “Media spaces” are another exemplary video communications technology that has shown promise. A “media space” is a nominally “always-on” or “nearly always-on” video connection between two locations, which has typically been used in the work environment. The first such example of a media space was developed in the 1980's at the Xerox Palo Alto Research Center, Palo Alto, Calif., U.S.A., and provided office-to-office, always-on, real-time audio and video connections. (See the book “Media Space: 20+ years of Mediated Life,” Ed. Steve Harrison, Springer-Verlag, London, 2009.)

As a related example, the “VideoWindow”, described by Robert S. Fish, Robert E. Kraut, and Barbara L. Chalfonte in the article “The VideoWindow System in Informal Communications” in the Proceedings of the 1990 ACM conference on Computer-Supported Cooperative Work, provided full duplex teleconferencing with a large screen, in an attempt to encourage informal collaborative communications among professional colleagues. Although such systems enabled informal communications as compared to the conference room setting, these systems were developed for work use, rather than personal use in the residential environment, and thus do not anticipate residential concerns and situations.

Also, connections in the Video Window are reciprocal, meaning that if one client is transmitting, so is the other, and if one is disconnected, so is the other. While reciprocity can be desirable in the work environment, it may not be desirable for communication between home environments. In particular, it can be preferable to allow each user site to determine when their side is capturing and transmitting, so as to give each household complete control over their own space and outgoing video material. The Video Window also utilized a large television sized display. It is questionable if such a display size would be suitable for the home.

Another related media space example is “CAVECAT” (Computer Audio Video Enhanced Collaboration And Telepresence), described by Marilyn M. Mantei, et al, in the article “Experiences in the Use of a Media Space” in the Proceedings of the 1991 ACM Conference on Human Factors in Computing Systems. With CAVECAT, co-workers run a client of the media space in their office and are then able to see into the offices of other co-workers who are similarly running media space clients. Videos from all connected offices are shown in a grid. Thus, the system is ostensibly designed for sharing live video amongst multiple locations. This contrasts with the home setting where connecting and sharing video between multiple households may not be desired. Instead, families may wish to only connect with another single home. CAVECAT was also intended to capture individuals within an office in a fixed location as opposed to groups of people. As such, the system was setup to provide close views of a single user and did not permit moving the system. This also contrasts the home setting where multiple people would be using or subject to a video communications system if placed in a common area of the home. Similarly, families may wish to physically move a video communications client depending on what activities they wish to share with remote family members.

Researchers have largely failed to pursue translation of the media space concept from the work setting to the home setting. While home directed media spaces have great potential to connect families over distance, assumed constraints related to privacy concerns and network bandwidth issues have limited interest in this application. As a result, research has instead directed their attention at other tools for connecting families that can provide an awareness of activities and health using abstracted representations, e.g., status indicators built into digital picture frames, lamps that turn on to indicate presence in a remote home.

Despite this minimalist research, many people are now turning to video communication systems for connecting with distance-separated family. This is evidenced by popular current usage of instant messaging systems that provide video communication channels such as Skype, Google Talk, or Windows Live Messenger. Therefore, it would be advantageous to develop video communications systems that are particularly optimized for the special issues that pertain to the home, including user privacy and ease of use, relative to variable user age and skill levels. Likewise, the variable range of user activities which may be captured during video communications, relative to user or viewer presence, the number and identity of the local users involved, or the changing nature of user activities during communications events, can all impact system design.

One exemplary prototype media space that has been tested in the residential environment is described by Carman Neustaedter and Saul Greenberg in the article “The Design of a Context-Aware Home Media Space for Balancing Privacy and Awareness” in the Proceedings of the Fifth International Conference on Ubiquitous Computing (2003). This system still has a work emphasis, as it describes the use of a system to facilitate communications between a telecommuter and in-office colleagues. The authors recognized that personal privacy concerns are much more problematic for home users than for office-based media spaces. Privacy encroaching circumstances can arise when home users forget that the system is on, or other individuals unwarily wander into the field of view of the system that resides in a home office. The described system reduces these risks using a variety of methods, including secluded home office locations, people counting, physical controls and gesture recognition, and visual and audio feedback mechanisms. However, while this system is located in the home, it is not intended for personal communications by the residents. As such, it does not represent a residential communication system that can adapt to the personal activities of one or more individuals, while aiding these individuals in maintaining their privacy.

A variety of systems have been developed with capabilities for recording video and playing it back at a later point in time. As an example, the W3 system (Where Were We), is described by Scott L. Minneman and Steve R. Harrison in the article “Where Were We: making and using near-synchronous, pre-narrative video” in the Proceedings of the 1993 ACM International Conference on Multimedia. Components of the W3 system are also described in U.S. Pat. No. 6,239,801 by Chiu et al., U.S. Pat. No. 5,717,879 by Moran et al., and U.S. Pat. No. 5,692,213 by Goldberg et al. The W3 system records meeting activities, including conversations between individuals and handwritten notes on a whiteboard, using both video and audio. These include implicit user actions such as writing on the whiteboard as well as explicit actions through a user interface create indices in the recorded content. Meeting participants can then review what has previously been recorded during the meeting in real time using the indices. Playback and reviewing can occur on any number of computers connected to the system. While this system is similar in concept to a media space, it is designed for meetings that are, generally speaking, short in duration (e.g., less than 75 minutes), rather than video communications systems or media space that may continue for extended periods of time (e.g., an entire day). W3 also assumes that all content is worthy of recording.

As another example, a system called “Video Traces,” is described by Michael Nunes, et al. in the article “What Did I Miss? Visualizing the Past through Video Traces” in the Proceedings of the 2007 European Conference on Computer Supported Cooperative Work. Video Traces records video from an always-on camera and visualizes it for later review. A column of pixels is taken from each video frame and concatenated with columns from adjacent video frames. Over the course of time (e.g., an hour, day, week, etc), a long series of pixel columns builds up and provides an overview of past activity that has occurred. Users can interact with this video timeline to review video. Clicking on a column of pixels within the timeline plays back the full video recorded at this time. This system presents one method for visualizing large amounts of video data and permitting users to quickly review it. The concatenated columns of pixels provide a high level overview of the recorded video. Yet this system does not provide networked support between two sites or clients, which renders the system as a standalone client and not a video communications system. Thus, it is not possible to review recorded video from multiple connected clients using this system. Also, all content, whether activity is occurring in the imaged area or not, is assumed to be worthy of recording and, as such, is displayed within the timeline. Video communication systems or media spaces within a home context do not necessarily always contain relevant or interesting video to transmit and/or record. Furthermore, transmitting or recording unnecessary video imposes additional constraints on network bandwidth.

To date, there has yet to be an instance of a media space for domestic use that temporally manages the recording and playback of video. We call this type of system a time shifted media space or time shifted video communications system because it allows users to shift the time that they view video recorded by the system. A time shifted media space or video communications system for the home must pay particular attention to the placement of the system in the home, as well as privacy concerns of all family members, and the activities the system captures (or does not), and the availability (or lack thereof) of remote viewers.

In summary, the development of systems for video capture of real time, unscripted events for video communications, from the socially, technically, and privacy constrained setting of the home, is a need that remains yet unfulfilled. In particular, the challenge with many commonly available video communication systems, as well as classical media spaces, is that they are not designed to easily fit within family routines and the context of the home. That is, they fail to address the situations and context that families need them to work within. Rather, their designs are migrated from work environments where they are generally designed for desktop computers that may or may not be situated in an easily accessible location in the home. They may also require family members to logon to the computer or launch the application prior to initiating communication. The prior art media space and video communications solutions also typically broadcast or stream all content regardless of activity or user presence. Taken together, these requirements make it much more difficult for families to initiate and use such technologies for everyday communication. Thus, families could benefit from an easily accessible video communications system that is simple to use and provides little barrier to entry and use.

### SUMMARY OF THE INVENTION

The present invention represents a method for providing video images to a remote viewer using a video communication system, comprising:

operating a video communication system, comprising a video communication client in a local environment connected by a communications network to a remote viewing client in a remote viewing environment, wherein the video communication client includes a video capture device, an image display, and a computer having a video analysis component,

capturing video images of the local environment using the video capture device during a communication event;

analyzing the captured video images with the video analysis component to detect ongoing activity within the local environment;

characterizing the detected activity within the video images with respect to attributes indicative of remote viewer interest;

determining whether acceptable video images are available, responsive to the characterized activity and defined local user permissions;

receiving an indication of whether the remote viewing client is engaged or disengaged; and

transmitting the acceptable video images of the ongoing activity to the remote viewing client if the remote viewing client is engaged, or alternately, if the remote viewing client is disengaged, recording the acceptable video images into a memory and transmitting the recorded video images to the remote viewing client at a later time when an indication is received that the remote viewing client is engaged.

The present invention has the advantage that it provides a solution for using video communications systems in a home environment where users may be engaged or disengaged with viewing the video communications system depending on what other activities are going on in the home environment.

It has the additional advantage that when remote users are not engaged in viewing the video images, the video images can be recorded for later viewing.

It has the further advantage that it provides a mechanism for both the sender and receiver of the video images to specify user preference settings to implement desired privacy rules.

### BRIEF DESCRIPTION OF THE DRAWINGS

FIG. 1 is an overall system figure depicting a video communications system, comprising video communications client devices linked between local and remote environments over a network;

FIG. 2 depicts a video communications client being operated in the context of a local environment;

FIG. 3A provides an illustration of the operational features of a video communications client device;

FIG. 3B depicts the operational features of one embodiment of a video communications client device in greater detail;

FIG. 4 depicts a flow diagram that illustrates an operational method for a video communications system according to the method of the present invention;

FIG. 5 is a table giving examples of various conditions that may be encountered in a video communication system, together with corresponding desired results; and

FIG. 6 depicts a time sequence of events or activities that are captured by a camera, along with associated video operational states and associated probabilities for determining the video operational states.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Families have a real need and desire to stay connected, especially when they become separated by distance. For example, they may live in different cities, or even different countries. This distance barrier can make it much more difficult to communicate, see a loved one, or share activities because people are not physically close to one another. Typically families overcome this distance barrier today by using technology such as phones, email, instant messaging, or video conferencing. Of all these, video is the technology that provides a setting most similar to face-to-face situations, which is people's preferred mode of interaction. As such, video has been considered as a potential communication tool for distance-separated families all the way back to the first incarnations of the AT&T Picturephone.

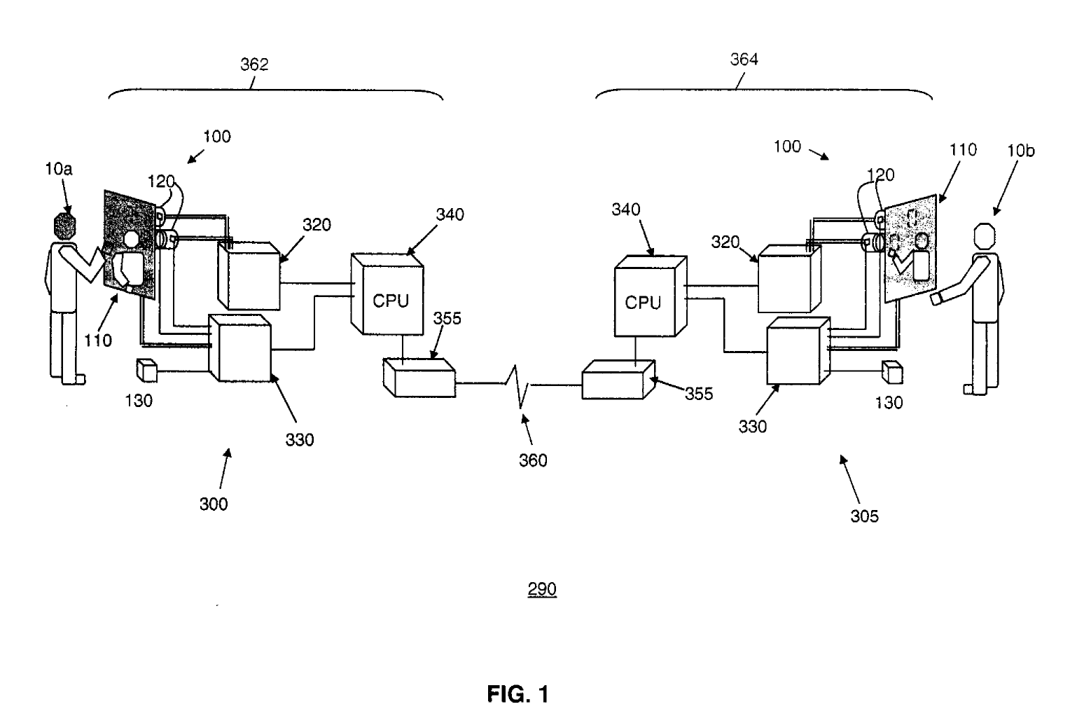

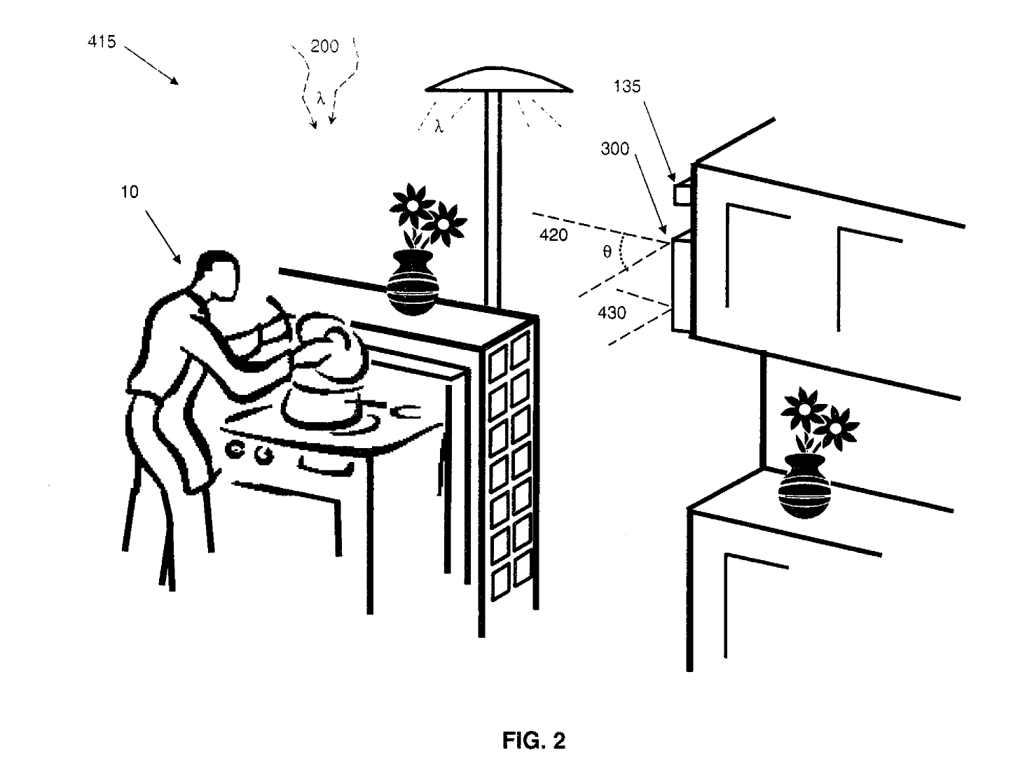

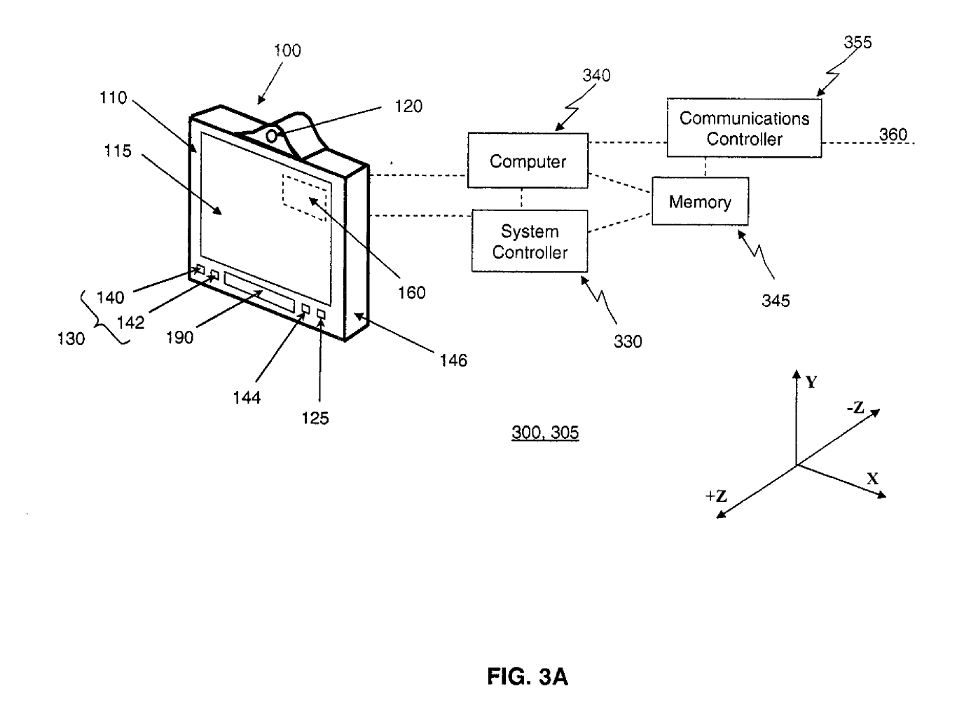

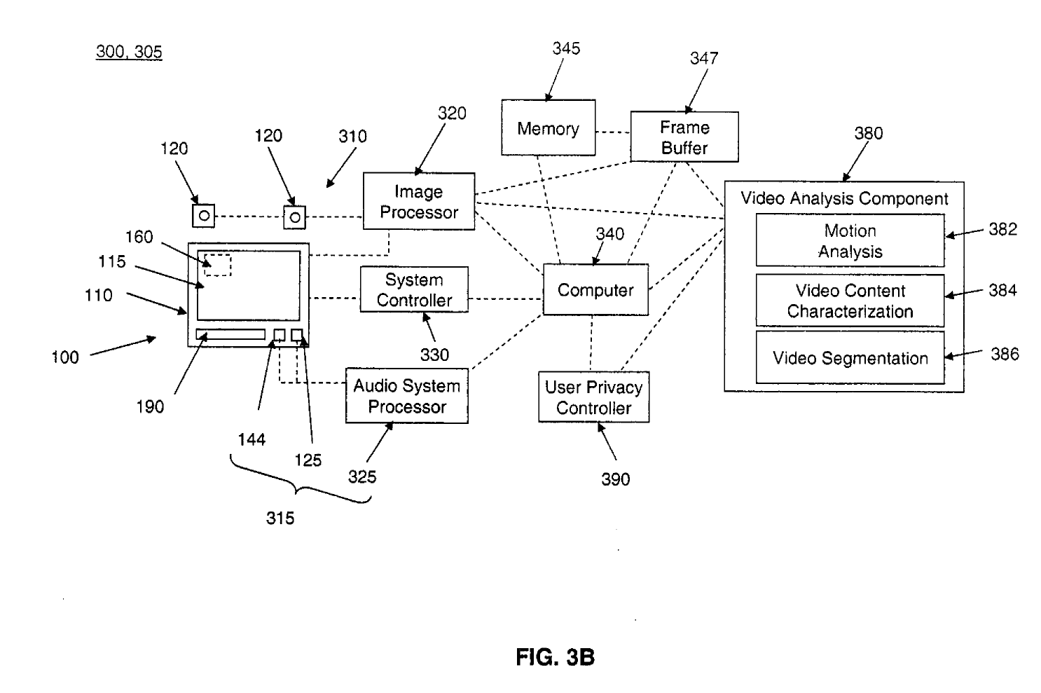

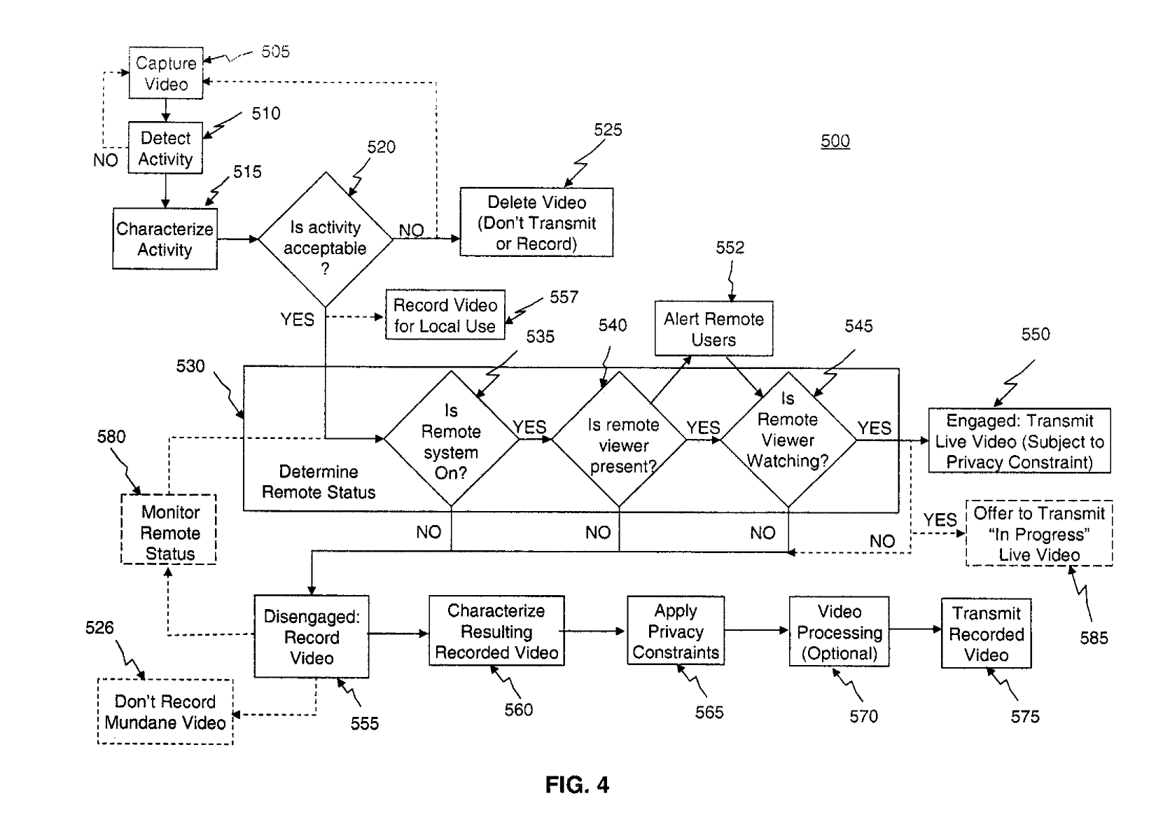

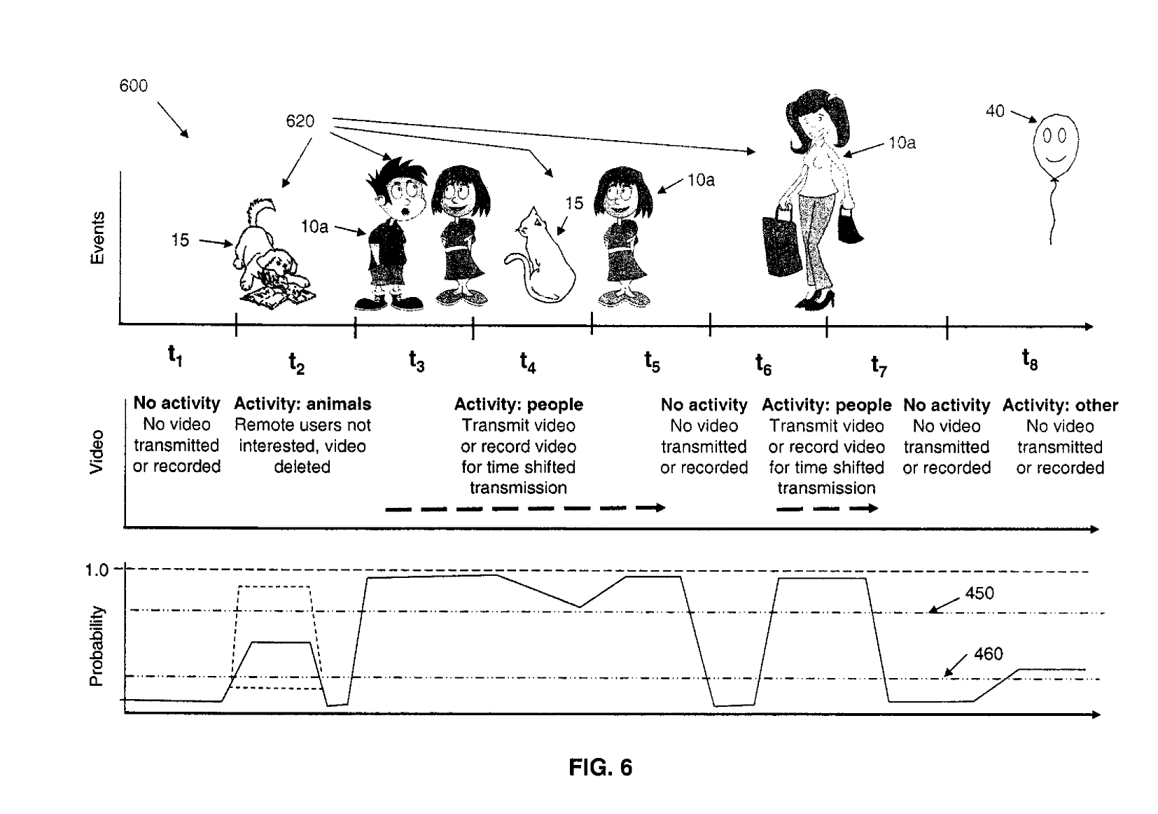

The present invention provides a networked video communications system 290 (see FIG. 1), utilizing video communication clients 300 or 305 (see FIGS. 3A and 3B) which capture video images using image capture devices 120, and which are operable using a video management process 500 (see FIG. 4), to provide video images of users 10 engaged in their activities during live or recorded video communication events 600 comprising one or more video scenes 620 (see FIGS. 2 and 6). In particular, the present invention provides a solution for an always-on (or nearly-always on) video communication system or media space that is particularly designed specifically for domestic use. At each site, the system can run in a dedicated device, such as a digital picture frame or information appliance, which makes it easy to situate the device in any location in the home conducive to video communications. It can also be provided as a function of a multipurpose device, such as a laptop computer or a digital television. In either case, the video communications system can be accessible on this device at the push of a single button and further provide features to mitigate privacy concerns surrounding the capture and broadcast of live video from the home. The system is also designed to capture and broadcast video over extended durations of time (hours or days), if desired by household members. Thus, the system can be left always-on, or nearly always-on, akin to media spaces for the workplace. This can permit remote households to view typical everyday activities, such as children playing or meal times, to better help distributed families feel more connected. Although the system can also be used for purposeful real time video communications, in a manner similar to typical telephone usage, the informal extended operation of this media space system is a mode atypical to telephone use.

The present invention is developed with recognition that several challenges still exist in adapting the concept of a media space to the home environment, in particular when it is used for extended durations of time.

First, bandwidth remains an issue. Broadcasting video between two or more homes continuously for extended durations of time requires a large amount of network bandwidth and can experience in latency issues. Thus, it can be desirable to reduce the amount of video being transmitted while still providing the potential benefits of such a media space for families. Thus, as one enabling feature of the present invention, a technique to sense user activities and presence in front of the residential media space or video communications system is provided. This system can then adjust its operational settings accordingly.

Second, it is recognized that individuals or family members who can view the captured and transmitted content may not always be present or available and thus can easily miss viewing content that may be relevant for them to see. For example, they may be home at different times during the day or may live in different time zones that do not align usage of the video communications system. Thus, the present invention provides a method to record content that may be missed and then it enables playback when viewers desire or are present in front of the video communications system. Again, this method relies on determining user (viewer) presence and availability to adjust recording and playback controls, based upon the determined status of the remote system or viewers (engaged or disengaged). Thus, the video communications system of the present invention utilizes a video management process to provide two modes of capture and record: live mode (provides ongoing video of current activities) and time shift mode (content that has been pre-recorded and can be later replayed when users are available to view it). As such, while the media space or video communications clients of the present invention can be operated continuously for extended periods of time, actual transmission or recording of video of real time events (activities) at a local media space or video communications client depends on a combination of activity sensing and characterization, as well as status determination relative to the remotely linked media space or video communications client.

This can be better understood by means of the block diagram of FIG. 1, which shows one embodiment of a networked video communications system 290 (or media space) having a local video communication client 300 (or media space client) located at a local site 362 and a similar remote video communication client 305 (or media space client or remote viewing client) at a remote site 364. In the illustrated embodiment, the video communication clients 300 and 305 each have an electronic imaging device 100 for communication between a local user 10a (viewer/subject) at the local site 362 and a remote user 10b (viewer/subject) at the remote site 364. Each video communications client 300 and 305 also has a computer 340 (Central Processor Unit (CPU)), an image processor 320 and a systems controller 330 to manage the capture, processing, transmission or receipt of video images across a communicative network 360, subject to handshake protocols, privacy protocols, and bandwidth constraints. A communications controller 355 acts as interface to a communication channel, such as a wireless or wired network channel, for transferring image and other data from one site to the other. The communications network 360 can be supported by remote servers (not shown), as it connects the local site 362 and the remote site 364.

As shown in FIG. 1, each electronic imaging device 100 includes a display 110, one or more image capture devices 120, and one or more environmental sensors 130. The computer 340 coordinates control of the image processor 320 and the system controller 330 that provides display driver and image capture control functions. The image processor 320, the system controller 330, or both, can optionally be integrated into the computer 340. The computer 340 for the video communications client 300 is nominally located at the local site 362, but some portions of its functions can be located remotely at a remote server within the networked video communications system 290 (e.g., at a service provider) or at the remote video communications client 305 at the remote site 364. In one embodiment of the present invention, system controller 330 provides commands to the image capture device 120, controlling the camera view angle, focus, or other image capture characteristics.

The networked media space or video communications system 290 of FIG. 1 advantageously supports video conferencing or video-telephony, particularly from one residential location to another. During a video communication event, comprising one or more video scenes, the video communication client 300 at the local site 362 can both transmit local video and audio signals to the remote site 364 and also receive remote video and remote audio signals from the remote site 364. As would be expected, the local user 10a at the local site 362 is able to see the remote user 10b (located at the remote site 364) as an image displayed locally on display 110, thereby enhancing human interaction. Image processor 320 can provide a number of functions to facilitate two-way communication, including improving the quality of image capture at the local site 362, improving the quality of images displayed at the local display 110, and handling the data for remote communication (by data compression, encryption, etc.).

It should be noted that FIG. 1 shows a general arrangement of components that serve a particular embodiment. Other arrangements can also be used within the scope of the present invention. For example, the image capture device 120 and the display 110 can be assembled into single housing, such as a frame (not shown), as part of the integration for a video communications client 300 or 305. This device housing can also include other components of the video communications clients 300 or 305, such as the image processor 320, the communications controller 355, the computer 340, or the system controller 330.

FIG. 2 depicts a user 10 operating a local video communications client 300 within his/her local environment 415 at a local site. In this exemplary illustration, user 10 is shown engaged in activities in a kitchen, which occur during one or more video scenes 620 or time events within a communication event 600. The user 10 is illuminated by ambient light 200, which can optionally include infrared light from an infrared (IR) light source 135, while also interacting with the local video communications client 300, which is mounted on a home structure. The video communication client 300 utilizes image capture devices 120 and microphones 144 (neither is shown in this figure) to acquire data from an image field of view (FOV) 420 from an angular width (full angle θ) and an audio field of view 430, which are shown by dashed lines as generally directed at a user 10.

FIGS. 3A and 3B then show additional details for one embodiment of the video communication clients 300 or 305. Each video communication client 300 or 305 is a device or apparatus that includes an electronic imaging device 100, image capture devices 120, a computer 340, a memory 345, and numerous other components, including video analysis component 380, which can be combined or integrated in varying ways. FIG. 3A, in particular, expands upon the construction of the electronic imaging device 100, which is shown as including an image capture device 120 and an image display device (display 110), having a display screen 115. The computer 340, together with system controller 330, memory 345 (data storage), and communications controller 355 for communicating with a communications network 360 can be assembled within a housing 146 of the electronic imaging device 100, or alternately can located separately and can be connected wirelessly or via wires to the electronic imaging device 100. The electronic imaging device 100 also includes at least one microphone 144 and at least one speaker 125 (audio emitter). The display 110 has picture-in-picture display capability; such that a split screen image 160 can be displayed on a portion of the screen 115. The split screen image 160 is sometimes referred to as a partial screen image or a picture-in-picture image.

The display 110 may be a liquid crystal display (LCD) device, an organic light emitting diode (OLED) device, a CRT, a projected display, a light guiding display, or any other type of electronic image display device appropriate for this task. The size of the display screen 115 is not necessarily constrained, and can at least vary from a laptop sized screen or smaller, up to a large family room display. Multiple, networked display screens 115 or video communications clients 300 can also be used within a residence or local environment 415.

The electronic imaging device 100 can include other components, such as various environmental sensors 130, a motion detector 142, a light detector 140, or an infrared (IR) sensitive camera, as separate devices that can be integrated within the housing 146 of the electronic imaging device 100. Light detector 140 can detect ambient visible light (λ), or infrared light. Light sensing functions also can be supported directly by the image capture device 120, without having a separate dedicated ambient light detector 140.

Each image capture device 120 is nominally an electronic or digital camera, having an imaging lens and an image sensor (not shown), which may capture still images, as well as video images. The image sensors can be CCD or CMOS devices, as commonly used in the art. Image capture devices 120 can also be adjustable, with automatic or manual optical or electronic pan, tilt, or zoom capabilities, to modify or control image capture from an image field of view (FOV) 420. Multiple image capture devices 120 can also be used, with or without overlapping image fields of view 420. These image capture devices 120 can be integrated within housing 146, as shown in FIG. 3A, or positioned externally as shown in FIG. 3B. In the case that the image capture devices 120 are integrated within housing 146, they can either be positioned around the display screen 115, or be imbedded behind the display screen 115. Imbedded cameras then capture images of the users 10 and their local environment 415 through the screen itself, which can improve the perception of eye contact between the users and the viewers. It is noted that an image capture device 120 and a microphone 144 may support motion detection functions, without having a separate dedicated motion detector 142. FIG. 3A also illustrates that the electronic imaging device 100 can have user interface controls 190 integrated into the housing 146. These user interface controls 190 can use buttons, dials, touch screens, wireless controls, or a combination thereof, or other interface components.

As FIGS. 3A and 3B further illustrate, the video communications client 300 also comprises an audio system 315, including a microphone 144 and a speaker 125 that are connected to an audio system processor 325, which, in turn are connected to computer 340. The audio system processor 325 is connected to at least one microphone 144 such as an omni-directional or a directional microphone or other devices that can perform the function of converting sonic energy into a form that can be converted by audio system processor 325 into signals that can be used by computer 340. It can also include any other audio communication components and other support components known to those skilled in the audio communications arts. Speaker 125 can comprise a speaker or any form of device known that is capable of generating sonic energy in response to signals generated by audio processor and can also include any other audio communication components and other support components known to those skilled in the audio communications arts. Audio system processor 325 can be adapted to receive signals from computer 340 and to convert these signals, if necessary, into signals that can cause speaker 125 to generate sound. It will be appreciated that any or all of microphone 144, speaker 125, audio system processor 325 or computer 340 can be used alone or in combination to provide enhancements of captured audio signals or emitted audio signals, including amplification, filtering, modulation or any other known enhancements.

FIG. 3B expands upon the design of the system electronics portion of the video communications client 300. One subsystem therein is the image capture system 310, which includes image capture device 120 and image processor 320. Another subsystem is the audio system 315, which includes microphone(s) 144, speaker(s) 125, and an audio system processor 325. The computer 340 is operatively linked to the image capture system 310, the image processor 320, the audio system processor 325, the system controller 330, and a video analysis component 380 as is shown by the dashed lines. Any secondary environmental sensors 130 can be supported by computer 340 or by their own specialized data processors (not shown) as desired. While the dashed lines indicate a variety of other important interconnects (wired or wireless) within the video communications client 300, the illustration of interconnects is merely representative, and numerous interconnects that are not shown will be needed to support various power leads, internal signals, and data paths. The memory 345 can be one or more devices, including a Random Access Memory (RAM) device, a computer hard drive or a flash drive, and can contain a frame buffer 347 to hold a sequence of multiple video frames of streaming video, to support ongoing video image data analysis and adjustment. The computer 340 also accesses or is linked to a user interface, which includes user interface controls 190. The user interface can include many components including a keyboard, joystick, a mouse, a touch screen, push buttons, or a graphical user interface. Screen 115 can also have touch screen capabilities and can serve as a user interface control 190.

Video content that is being captured from the image capture device 120 can be continually analyzed by the video analysis component 380 to determine if the video communications client 300 should be processing the video for transmission or recording, or alternately allowing the video to disappear out of the frame buffer 347. Similarly, signals or video being received from other remote video communications clients 305 (FIG. 1) can be continually analyzed by the video analysis component 380 to determine whether the locally captured video should be transmitted immediately or recorded for later transmission and playback, and whether any video received from the remote client should be played locally or saved for later viewing. It is noted that video captured with the local video communications clients 300 can be recorded or stored at either the local video communications clients 300 or the remote video communications clients 305.

FIG. 4 shows one embodiment of an operational video management process 500 that be used by the video communications client 300 to determine whether time events that are occurring in the real time video stream are communication events 600 or video scenes 620 which are to be utilized (transmitted or recorded) or non-events or inactivity to be dropped (deleted from the frame buffer 347). The video management process 500 includes video analysis of the ongoing video capture to detect (or quantify) activity, followed by video characterization to determine whether the detected activity is acceptable (for video transmission or video recording) or not. The video analysis for video management process 500 is provided by a video analysis component 380 that comprises one or more algorithms or programs for analyzing the captured video. For example, as shown in FIG. 3B, the video analysis component 380 can include a motion analysis component 382, a video content characterization component 384, and a video segmentation component 386. If the video content is deemed acceptable per the acceptability test 520 of FIG. 4, then a series of decision steps can ensue, to determine whether a user 10 at a remote video communications client 305 (or remote viewing client) is considered engaged (available to view live video of ongoing activities) or disengaged (not available to view live video). In the former ease, video is transmitted live (see transmit live video step 550) to the remote video communications client 305. In the latter case, a series of steps (see record video step 555, characterize recorded video step 560, apply privacy constraints step 565, video processing step 570, and transmit recorded video step 575) can follow to record, characterize, and process the video prior to transmission for time-shifted viewing.

In greater detail with respect to video management process 500, the video analysis component 380 first detects activity in front of the video communications client 300 using a detect activity step 510 to analyze video captured with a capture video step 505. The video analysis component 380 particularly relies on video data collected by the image capture device 120 and processed by the image processor 320, which is passing through a frame buffer 347. Activity can be sensed by the detect activity step 510 using various image processing and analysis techniques known in the art, including video frame comparison to look for image differences that occur between a current frame and prior frames. If substantial changes exist, then it is likely that activity is occurring. The activity level can be quantitatively measured using metrics related to various characteristics, including the velocity (m/s), acceleration (m/s²), range (meters), geometry or area (m²), or direction (in radial or geometrical coordinates) of motion, as well as the number of participants (users or animals) involved. Most simply, a certain amount of detected activity may be required to indicate that something is happening, for which video can be captured. As another example, simple motion or activity analysis can distinguish scene changes and provide metrics that indicate the presence of animate beings from motion metrics typical of the motion of common moving inanimate objects. For example, motion frequency analysis can be used to detect the presence of human beings.

As stated previously, the video communications client 300 can also use data collected from other environmental sensors 130, including infrared motion detectors, bio-electric field detection sensors, microphones 144, or proximity sensors. In the case of an infrared motion detector, if motion in the infrared field is detected, then it is likely that activity is occurring. In the case of a proximity sensor, if changes in the distance of an object in front of the sensor occur, then it is likely that activity is occurring. While the motion analysis component 382 can include video motion analysis programs or algorithms, other motion analysis techniques can be provided that use other types of sensed data (including audio, proximity, ultrasound, or bio-electric fields) as appropriate. Depending on the various environmental sensors used, and the type of data they collect, the video communications client 300 may receive preliminary awareness or alerts that a time event of potential interest may occur before that event becomes visible in the video stream. These alerts can trigger the video communications client 300 into a higher monitoring or analysis state in which the video analysis algorithms are used more aggressively. Alternately, these other types of sensed data can be analyzed to provide validation that a potential video event is really occurring. For example, as described in U.S. patent application Serial No. 12/406,186, by P. Fry et al., entitled “Detection of animate or inanimate objects”, signals from bio-electric field sensors and cameras can be used jointly to distinguish the presence of animate (alive) objects from inanimate (non-living) objects. Potentially, the video communications client 300 can transmit or record audio of a 31) given communication event 600 from a time point before video of the activity for that event becomes available.

However, in general, once the video communications client 300 is turned on, the video analysis component 380 is continuously capturing video using the capture video step 505, during which it is then seeking to detect activity in the video stream using detect activity step 510. If activity is detected, the video analysis component 380 next applies a characterize activity step 515 using the algorithms or programs of the video content characterization component 384 to determine if the captured video content is acceptable to be transmitted or recorded or both. These algorithms or programs characterize the video content, based for example, on face detection, head shape or skin area detection, eye detection, body shape detection, clothing detection, or the detection of articulating limbs. Preferably, the video content characterization component 384 is thus able to determine the presence of an animal or person (user 10) in the video from other incidental motion or activity, and then further distinguish the presence of a person from that of an animal. In the case that a person is present, the video content characterization component 384 can optionally also characterize the ongoing activity by activity type (such as eating, jumping, or clapping) or determine human identity using face or voice recognition algorithms. Furthermore, the video content characterization component 384, in cooperation with the motion analysis component 382, can quantitatively analyze the activity level to determine when activity levels are changing.

For example, using eye or face detection algorithms within video content characterization component 384, the video analysis component 380 can determine if a person is in the scene captured by the image capture device 120. In the case where a person's head pose is turned to the side, or their head is obscured, and face detection is unable to accurately determine if a person is in the video scene, other algorithms such as head shape or body shape detection can provide the determination. Alternately, motion tracking, or articulating limb based motion analysis, or a probability tracking algorithm that uses the last known time a face was detected, along with a probability analysis, can determine that a person is still in the video scene even though their head pose has changed (which may have made face or eye detection more difficult).

Once activity is detected in the video images by detect activity step 510, and then characterized by characterize activity step 515, the video communications client 300 next determines whether the video content is acceptable for video transmission or recording using an acceptability test 520. Acceptability can be determined by user preference settings provided by local users of the video communications client 300, or by user preference settings provided by remote viewers. Typically, these user preference settings will have been previously established by users 10 via the user interface controls 190. Default preference settings can also be provided and used by the video communications client 300 unless they are overridden by a local or remote user.

In general, both local and remote users can determine the types of video content they consider as acceptable, either to transmit or receive with respect to their own video communications client 300. That is, users 10 can both determine what types of video content they consider acceptable to be transmitted by their video communications client 300 to be shared with remote video communications clients 305, as well as what types of video they consider acceptable to receive from other remote video communications clients 305. In general, the local user's preference settings or permissions have priority in determining what content is available to be transmitted from their local site, whether any particular remote users wish to watch it or not. However, the remote users then have priority in determining whether to accept the available content to their remote video communications client 305. If users 10 fail to provide preference or permission settings, then default preference settings can be used.

Acceptability can depend upon a variety of attributes, including personal preferences, cultural or religious influences, the type of activity, or the time of day. The acceptability of the outgoing content may also depend on who the recipients are, or whether the content is transmitted live or recorded for time shifted viewing. For example, users can select one or more types of video content, such as video with people, video with pets, or video with changes in lighting to be transmitted or recorded. For example, video with changes in lighting, which may be generally considered mundane, can indicate changes in weather outside if the camera captures areas containing or near windows, or it could indicate changes in the use of artificial lighting in the home indicative of going to sleep at night or waking up in the morning. Acceptability can also be defined with an associated ranking, for example from highest acceptability (10) to totally unacceptable (1), with intermediate rankings, such as mundane acceptability (4). This information can then be transmitted to remote video communications clients 305 to indicate the type of video that is available. Other characterization data, particularly semantic data describing the activity or associated attributes (including people, animals, identity, or activity type) can also be supplied. Users 10 can also update this list on an as-needed basis during their usage of the video communications client 300. Any updates can be transmitted to any or all designated remote video communications clients 305 and the video analysis component 380 then uses the new preference settings for selecting acceptable content.

The acceptability test 520 can operate by comparing the results or values obtained by characterizing the activity, or attributes thereof, appearing in the captured video content to the pre-determined acceptable content criteria for such attributes or activities, as provided by the local or remote users of the video communications clients 300 and 305. If the activity is not acceptable, video is not transmitted in real time to the respective remote video communications clients 305, nor is it recorded for future transmission and playback. In this case, delete video step 525 deletes the video from the frame buffer 347. Ongoing video capture and monitoring (capture video step 505 and detect activity step 510) can then continue. As an optional alternative, local user preferences can initiate a record video for local use step 557, during which acceptable video image content of activity in the local environment is automatically recorded, regardless of whether the resulting recorded video is ever transmitted to a remote site 364 or not. This resulting recoded video can be characterized, subjected to privacy constraints, and processed, in a similar manner to the time-shifted video that is recorded for transmission.

If, however, acceptability test 520 determines that the activity is acceptable, the video analysis component 380 can then determine the status of any remote video communications clients 305 (or remote viewing client) that are currently connected to the user's video communications client 300 using a determine remote status step 530. The exemplary embodiment of FIG. 4 shows the determine remote status step 530 as performing a series of tests (remote system on test 535, remote viewer present test 540, and remote viewer watching test 545) to determine the status of the remote video communications client 305 or remote user 10, as engaged or disengaged. The video communications client 300 can notify any or all other remote video communications clients 305 to which it is linked over the communications network 360 that live video content of current ongoing activities is available. The remote video communications clients 305 can then determine viewing status at the remote sites 364 and transmit various status indicators back to the local, content originating, video communications client 300. The determine remote status step 530 can then perform various tests to assess the significance of any received status indicators.

A remote system on test 535 can determine whether a remote system is in an “on” or “off” state. Most simply, if a remote video communications client 305 is off then a “disengaged” status can be generated that can trigger record video step 555 which records video at the local site. (In instances Where the local video client is simultaneously interacting with multiple remote video communications clients 305 across communications network 360, mixed status indicators can result in both live video transmission and time shifted video recording of the same video scenes 620.)

When remote system on test 535 determines that a remote video communications client 305 is on, then more remote status information is needed. Next a remote viewer present test 540 is used to determine whether one or more remote users are present at the site of the remote video communications client 305. For example, the remote viewer present test 540 can apply audio sensing, motion sensing, body shape, head pose, or face recognition algorithms to determine whether remote users are present. Most simply, if no one is present in front of the remote video communications client 305, then again a “disengaged” status indicator can be generated that can trigger record video step 555 which records video at the local site 362.

Mere presence of a potential user 10 may not indicate user availability, as the user's attention may not be available tar viewing video content coming from the local video communications client 300. Remote viewer watching test 545 attempts to resolve this issue. As one approach, the remote video communications client 305 can assess remote viewer attentiveness by determining when one or more remote viewers are actually watching their display 110 by monitoring the eye gaze of users 10 in front of the display 110. The remote video communications client 305 can also estimate whether or not the remove viewer is watching using face recognition algorithms: if a face is recognized, then the person's face must be in complete view of the display 110 and there is a high likelihood that the user 10 is watching the display 110. Similarly, if a remote user 10 is currently interacting with the remote video communications client 305 (for example by pushing a button on the user interface controls 190), then the video communications client 300 can resolve with high likelihood that the user is watching the display 110. In such instances, the remote viewer watching test 545 can provide an “engaged” status indicator that can trigger a transmit live video step 550, enabling video transmission from the local site 362. If the remote viewer watching test 545 provides a “disengaged” status indicator, then the record video step 555 is triggered to record video at the local site.

Of course, it is also possible that a remote user may be present, and viewing the display 110, but for other purposes than viewing live video content transmitted from across the communications network 360 from the local video communications client 300. Therefore, the remote video communications client 305 can provide an alert (audio or visual) to the remote users, via an alert remote user step 552, to indicate that real-time content is available to them from one or more networked video communications clients 300. Semantic metadata describing the activity, such as the presence of animals or people, or activity type, can also be supplied to the remote user to help them determine whether they are interested in viewing the video. This semantic data can also help a remote communications client 305 automatically link viewable content to viewer identity, so that content can be offered to particularly interested potential viewers. A real time video feed can also be supplied for a short period of time to see if viewer interest can be sparked. The remote user 10 can then simply get into position to watch the video, at which point the remote viewer watching test 545 can provide an “engaged” status and the local video communications client 300 can activate the transmit live video step 550. Alternately, using their user interface controls 190, remote users can indicate their willingness to view the real time video content from one or more networked remote video communications clients 305. This willingness, or lack thereof, can be provided to the remote viewer watching test 545 as a status indicator signal.

In instances where the remote viewer watching test 545 determines that an engaged remote viewer is present, live video transmission can commence using the transmit live video step 550. However, when the status of a remote video communications client 305 or remote user 10 is resolved as disengaged, then video recording can commence using the record video step 555. Once the video is recorded, it can be semantically characterized using characterize recorded video step 560. For example, the characterize recorded video step 560 can make use of the video content characterization component 384 to identify the activities (activity types) and the users or animals captured therein. The characterize recorded video step 560 can also include time segmentation using video segmentation component 386, to determine an appropriate duration for the recorded video of the communication event 600. Additionally, any privacy constraints can be referenced and applied by apply privacy constraints step 565. The recorded video can optionally be processed using video processing step 570 according to the characterization and privacy constraints. For example, a recorded video can be shortened in length, reframed, or amended by obfuscation filters. Transmit recorded video step 575 can then be used to transmit the recorded video to approved remote video communications clients 305, with accompanying metadata describing the video (such as activity, people involved, duration, time of day, location, etc. . . . ). The recorded video can be segmented into multiple video clips by the video communications client 300 prior to transmission if their length exceeds a threshold of time. Segmentation can occur based on a combination of suitable video lengths for data transmission and changes in activity as detected by the video analysis component 380. Live video transmission or video recording for time shifted viewing stops when the conditions for transmission or recording are no longer satisfied. The local video communications client 300 can then revert to the capture video and detect activity steps 505 and 510.

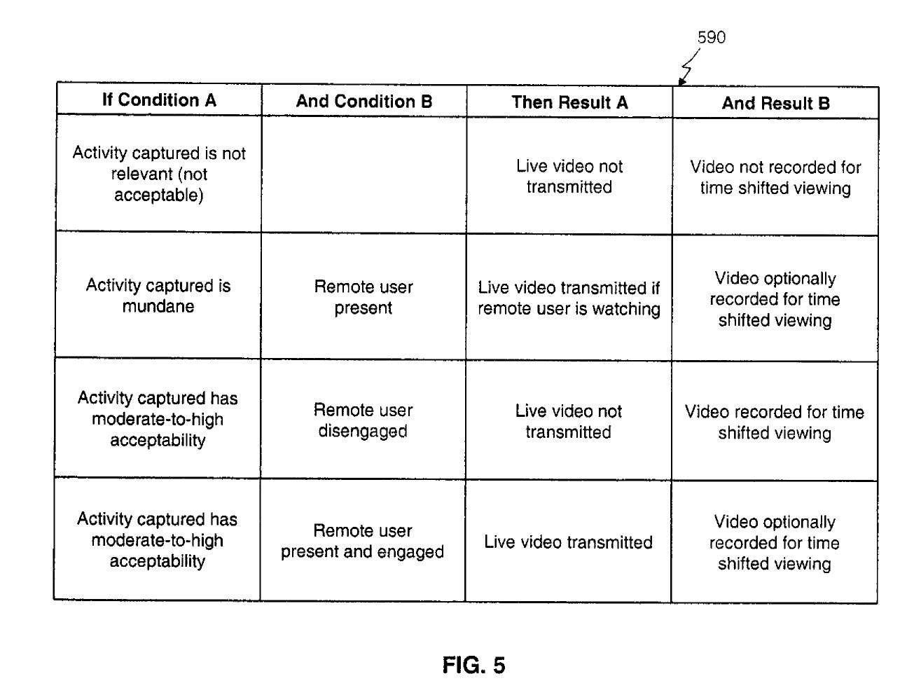

As just described, the exemplary video management process 500 utilizes a series of steps and tests to determine how to manage available video content. FIG. 5 illustrates a table showing another view of a variety of conditions can lead to live video transmission, video recording for time shifted viewing, or deleted video (i.e., not transmitted and not recorded). In a first example (first row), the acceptability test 520 determines that available video content is not acceptable for transmission (e.g., ranking=1) using comparisons of the characterized video content attributes to user preferences related to the determined video content attributes. The result is that the video content will not be transmitted or recorded, regardless of remote viewer or remote client status.

In a second example (second row of the table in FIG. 5), the acceptability test 520 determines that the available video content has acceptable content, but is considered mundane or of uncertain interest (e.g., rankings=3-5). For example, mundane content may comprise video of only a cat. In this example, remote system on test 535 determines that a remote video communications client 305 is on and remote viewer present test 540 determines that a remote user 10 is present. If the remote user 10 is willing to view the mundane or marginal interest content, the viewer is deemed engaged, and live video content of the ongoing mundane activity is transmitted (using transmit live video step 550). On the other hand, if the remote viewer is not interested in watching the mundane content as live video, a “disengaged” classification can initiate record video step 555, unless user preference settings indicate that video having a mundane content acceptability classification should not be recorded. In that case, any ongoing video recording or transmission can be stopped via delete mundane video step 526.

In a third example (third row of the table in FIG. 5), the acceptability test 520 determines that the available video content has acceptable content, enabled by the video analysis component 380 classifying the video as moderately to highly acceptable (e.g., ranking=6 or higher). If the determine remote status step 530 returns a status of disengaged (indicating that the remote system is off or a remote viewer is not watching), the live video will not be transmitted but will be recorded in anticipation of future time-shifted transmission and playback.

In a fourth example (fourth row of the table in FIG. 5), the acceptability test 520 determines that the available video content has acceptable content and classifies the video as moderately to highly acceptable (e.g., ranking=6 or higher) as in the third example. However, in this case, the determine remote status step 530 returns a status of engaged (indicating that the remote system is on and a remote viewer is watching). Therefore, the video captured by the image capture device 120 of the ongoing activities is transmitted and played on the remote video communications client 305 in live mode. Optionally, the video content can also be recorded for time-shifted viewing at a later time (for example, if a second remote system is found to be disengaged or the remote viewer has requested both live video transmission and video recording).

While FIG. 5 illustrates several basic circumstances that can determine video transmission, video recording, or video content deletion, circumstances can be dynamic, and change the current video state. In particular, remote viewer interest, as originally determined by use of the user interface in responding to a video available alert, or by video analysis of the remote viewer environment, can change. As one example, a remote video communications client 305 that was on without a user present, may send a signal that a potential viewer is now present. In this case, monitor remote status step 580 (FIG. 4), can facilitate a dynamic system response. As an example, the local video communications client 300 can provide a signal indicating that an “in progress” video is available. An offer “in progress” video step 585, enabled by audio or visual alerts, can be used to offer a live video transmission to be watched on the remote video communications client 305 to the remote user 10. If a remote user then becomes “engaged” as a viewer, the ongoing portion of the “in progress” video can be transmitted (using transmit live video step 550), although the entire communication event 600 can still be recorded (using record video step 555).

Alternately, a remote user may start watching live video from the local video communications client 300 on their remote communications client 305, but then lose interest or availability. If a remote user starts to watch a live video feed, but is concerned that they may be distracted or diverted before the video event concludes, the remote user 10 can request concurrent live video transmission and video recording. The remote user can also request that video recording commence for an ongoing “in progress” video event that was being transmitted live without recording.

In the case that video has been locally recorded for time shifted transmission and playback, a remote video communications client 305 can either passively or actively offer the recorded video for viewing by a remote user 10. For example, in a passive mode, an icon can indicate that a video is available for viewing. Remote users may then activate the icon to learn more details (as determined by characterize recorded video step 560) about the video content, and perhaps decide to watch it. In an active mode, the local video communications client 300 can receive signals indicating that a remote video communications client 305 is on and that a remote user is present and interacting with the remote video communications client 305. In this case, the remote user can be prompted to begin playback of the time shifted video. The remote user can choose to either play it back at that time or to wait and watch it later by making an appropriate selection using user interface controls 190. Alternately, depending on user preference settings, if remote users are determined to be present in front of the remote video communications client 305 for a specified length of time, time shifted video can be automatically played to provide a passive viewing experience.

Of course, a variety of alerts notifiers can be used, including thumbnail or key frame images, icons, audio tones, video shorts, graphical video activity timelines, or video activity lists. Alert notification is not inherently limited in delivery to the remote video communications client 305, as an opportunity to view live or recorded video can also be communicated through cell phones, wirelessly connected devices, or other connected devices.

In the prior examples, the receiving video client can provide alerts either passively or actively to the potential remote viewers that video content from the sending video client is available. Alternatively, the remote video communications client 305 can suggest a list of recorded video clips or records that are available for subsequent viewing, where the list of video records is summarized by semantic information relating to the context of the records, including specific events, parties, activities, participants involved, or chronological information. The summary list may be offered for previewing and selection using titles of events or stories, semantic descriptions, key video frames, or short video excerpts. A remote viewer then can select the desired pre-recorded information for viewing. At that time the selected video events can be transmitted. Alternately, if the entire list of prerecorded video has been already transmitted, the selected material can be displayed for viewing, and the remaining material can be automatically archived or deleted.

In another embodiment, a remote video communication client 305 can suggest a prioritized queue or list of records based on a variety of semantic information that has been collected at either the local site 362 or the remote site 364. The semantic, contextual, and other types of information about the remote viewers or the local users can be acquired via the user interface, video and audio analysis using appropriate analysis algorithms, or other methods. This semantic information can also include data regarding remote viewer characteristics (identities, gender, age, demographic data), the relationships of the remote viewers to the local users, psychographic information, calendar data (regarding holidays, birthdays, or other events), as well as the appropriateness of viewing given video captured activities. The video communication clients can also compile and analyze semantic data profiling the history of viewing behavior, the types of video captured material previously or routinely selected for viewing, or other criteria. This type of information about the remote viewer can be readily available to the video clients based on reciprocal recording and viewing at the remote viewer site, as accomplished during a history of two-way video communication.

For example, if the remote viewer is a grandmother who has a pattern of preferentially viewing transmitted live or recorded video that involves her grandchildren, the remote video communication client can prioritize and offer video clips for viewing which have her grandchildren in them. As another example, if the remote viewer is a father who enjoys watching the same sporting activities on TV as his son does, then the remote video client can offer the father the opportunity to view both the sporting activity itself, as well as ongoing video of his son watching the same sporting activity. The system can also automatically alert the viewer that a real time record of potential interest is taking place, so the real time video communication can then be established and both parties can enjoy a synchronous shared experience, such as a party, dinner or movie watching. Finally, an emotional response of the remote viewer can be recorded by the remote video client using facial expression recognition algorithms, audio analysis method, or other methods, so as to learn for example what specific events, content, or user and viewer relationships, are of particular interest, so that the available video records can accordingly be transmitted, archived, highlighted by alerts, or prioritized for viewing.

The remote users 10 can also access any pre-recorded video through the user interface controls 190 by selecting video clips and choosing to play them. When viewing recorded video content, users can control the video playback by performing various operations such as pause, stop, play, fast forward, or rewind. The user interface controls 190 can present a graphical timeline that displays: the level of activity throughout a given time period (e.g., day, week, month, etc) at the video communications client 300 that provided the video, the location of the recorded video clips comprising one or more video communication events 600 within the displayed time period, and the specific point in time for which the user is viewing either live or recorded video. This helps users understand how the video clip fits within a given time period. Activity level is determined for the timeline using the values derived by the video content characterization component 384.

It is to be expected that local users 10 will want various mechanisms to maintain their privacy and control video content that is made available from their video communications client 300. For example, users 10 can use their user interface controls 190 to manually stop their video communications client 300 from capturing, recording, or transmitting video. This operation can cause live video transmission, as well as video recording for time shifted playback, to cease. Similarly, no video is captured or transmitted while the image capture device 120 is turned off, although pre-recorded video can still be transmitted based on the previously described criteria. Users 10 are also able to manually start and stop the recording of video on their local video communications client 300 for time shifted viewing. Thus, live video can be deliberately recorded for later replay. In this way, users can have full control over recording, if desired, and can record special segments of video such as a child playing or taking her first steps. These can then be transmitted by the local video communications client 300 to a remote video communications client 305 for time-delayed viewing.

A variety of other privacy features can also be provided by the video communication system 290 of the present invention. For example, the user interface controls 190 can enable users 10 to select a range of privacy filters, which can be applied sparingly, liberally, or with content dependence, by the user privacy controller 390 (FIG. 3B). Users 10 are able to set these privacy expectations within the user interface controls 190 by selecting from any number of video obfuscation filters, such as blur filtration, pixelize filtration, privacy-filtering techniques similar to real world window blinds, along with associated values of obfuscation which determine how much video is obscured or masked. In the case of blur filtration, image processing techniques known in the art are applied to blur the image using a convolution kernel. In the case of “window blinds”, rows of pixels can be blocked and not transmitted akin to the manner in which people “block” portions of a window with real world blinds. Other filters, such as audio-only, video image only, or intermittent still image only, can also be selected or customized. The application of the obscuration privacy filters can also depend on video content or semantic factors, including the presence of people or animals, identity, activity, or the time of day. Likewise, the privacy filters can determine circumstances during which only live video transmission, only recorded video capture, or both live video transmission or recorded video capture are permitted. In each case that video is determined to be suitable for transmitting, the user privacy controller 390 can apply privacy constraints to the video prior to its transmission. This is done for both the transmit live video step 550 (FIG. 4) as well as the transmit recorded video step 575.

Users 10 also can use their user interface controls 190 to set privacy options specifically for the viewing of their time-shifted recorded video, which are then managed by privacy controller 390. For example, users 10 can set these options for each remote video communications client 305 that they are connected to. Default values are applied to new remote video communications clients 305 that connect, although users 10 can update these. Users 10 can also choose both how many times recorded content can be viewed and the lifespan of recorded content. For example, a user 10 may select that recorded content can only be viewed once for privacy reasons because they do not want potentially sensitive activities to be watched repeatedly. In contrast, they may also choose to allow video to be watched multiple times so that multiple family members may see the video in the case that not all are around their video communications client 300 at the same time. To conserve data storage space on the computer, users 10 may also select how long recorded video remains on their computer. After a set time span, recorded video may be automatically deleted.

It can be anticipated that some users 10 may want to limit the viewing of their content, whether delivered as live video or recorded video, to viewing by only certain designated users 10. User identity can be verified by a variety of means, including face recognition, voice recognition, or other biometric cues, as well as passwords or electronic keys.

For the video communications system 290 shown in FIG. 1, having a local video communications client 300 and a second networked remote video communications client 305, the roles of sender and receiver are nominally reciprocal, in that either client can send or receive either live or time shifted video. Also as previously described, video content from a local environment 415 is recorded by the local video communication client 300 at the local site 362, rather than by a remote video communication client 305 at a remote site 364. As such, local users 10 are better able to control the privacy of their content. However, there can be circumstances in which local users 10 are willing to allow the video recording of live events from their own local site 362 to occur remotely rather than locally. Therefore, in an alternate embodiment of the present invention, the recording of video from a first local site 362 to a memory 345 in a remote video communications client 305 at a second remote site 364 can be enabled. In such instances, the tests within the determine remote status step 530 can be performed on the remote video communication client 305 using the status indicators for activity at the remote site 364. As yet another alternative, it should also be understood that video management process 500 can be undertaken in circumstances where the determine remote status step 530 is performed on the remote video communication client 305, and the video is first recorded onto the memory 345 of the local video communication client 300. As can be seen, these alternate operational embodiments are not necessarily reciprocal.

It is also noted that a variety of other user features can also be provided. Local users 10 can influence the alerts provided to gain attention of remote users using alert remote users step 552 for viewing either live or recorded video. For example, local users 10 can be enabled to select a sound to be played at the remote location to get a remote user's attention. Users at each video communications client 300 can select what sounds are linked to this function and played when remote users push the notification button in their video communications client 300. When video is being transmitted in live mode, sound notifications are played in real time along with the video. When video is being recorded as part of time-shift mode, notification sounds can be recorded and played back, along with the video, in the same time sequence in which they occurred.

As other options for user interface controls 190, the video communications clients 300 can also be equipped with various user interface modalities, such as a stylus for stylus-interactive displays, a finger for touch-sensitive displays, or a mouse using a regular CRT, LCD, or projected display. Users 10 can utilize these features to leave handwritten messages or drawings for remote viewers. Users 10 can also erase messages and change the color of their writing. In live mode, these messages are transmitted in real time. In time shifted mode, messages are recorded and then played back in the same time sequence that they were drawn. This lets viewers understand at what point in time messages were written.

Users 10 can also turn on an optional audio link that transmits audio between video communications clients 300 using one or more interaction modalities, such as by pushing and holding a button, or pushing an on/off button for longer audio transmissions. If the video communications client 300 is in live mode, audio is transmitted in real time. If the video communications client 300 is in time shift mode, audio is recorded with the video and when playback occurs, the audio is played back in the same time sequence in which it was originally captured.

FIG. 6 depicts an exemplary use of a media space or video communications client 300, involving a communication event 600 comprising a sequence of potential video scenes 620. As shown in the top portion of FIG. 6 labeled “events”, a sequential series of time events are occurring within time periods t₁ through t₈, which have associated video scenes 620. The video scenes 620 are contiguous, but not necessarily of equal duration. A communication event 600 nominally comprises a series of contiguous or time adjacent video scenes 620, which can be shared between local users and remote viewers as live video, recorded video, or both. The middle portion of FIG. 6 labeled “video” then illustrates a series of video capture actions that the video communications client 300 can provide in association with the different time events (time periods and video scenes 620). In this example, the local users 10a have adjusted their user preference settings to allow transmission of live or recorded video that involves either people or animals, but a remote user 10b has adjusted his user preference settings to view content containing people, but not content containing only animals.

During time period t₁, the local video communications client 300 at the local site 362 detects that there is no activity in the associated video scene 620 and chooses not to transmit either live or recorded video to the remote video communications client 305 at a remote site 364. Communication event 600 therefore likely does not include the video scene 620 associated with time period t₁, although a portion of the time period t₁ proximate to the time period t₂ may be included, if the video captured for the video scene associated with time period t₂ is transmitted or recorded. Optionally, users can adjust their user preference settings to specify that the local video communications client 300 should transmit occasional still frames, in the case that remote users 10b are near their remote video communications clients 305 and may glance at it to see the status of activity at the location of the first networked remote video communications client 305.

During time period t₂, activity is detected by the video analysis component 380 of the local video communications client 300, and it is determined that an animal 15, rather than a person (a local user 10a) is present. The local video communications client 300 can transmit, record, or delete this video content, but since people are not present and the remote video communications client 305 indicates disinterest in animal-only content, this content is deleted (video is not transmitted or recorded). In this example, the video scene 620 associated with time period t₂ does not become part of a communication event 600. As before, occasional still images can optionally be transmitted depending on the user preference settings.

During time period t₃, two children (local users 10a) enter the local environment 415 and the field of view 420 of the image capture device 120, and the local video communications client 300, using video analysis component 380, detects this activity and recognizes that there are two people in the video scene 620. If a remote video communications client 305 is on and at least one remote user 10b is present and watching the remote video communications client 305 (one or more remote users are engaged), then a communication event 600 commences during which live video of the activity is transmitted and played at the remote site 364. However, if the remote client is not on, or at least one viewer is not present and watching, then the video of is recorded for later transmission and playback.

During time period t₄, an animal 15 now appears in the video scene 620. A variety of circumstances can occur, including that both the animal and children are present in the video content, only the animal is present in the video while the children are still detected in the audio, or only the animal is present. For example, in the first case, the communication event 600 continues via video transmission or recording. In the case that only an animal is present, live video transmission or video recording can continue until it becomes clear that the children will not reappear, or another person appears, in the video before a time threshold passes. In the case of live video transmission, the transmission and communication event 600 would end once the time threshold has passed. Of course, with recorded video, if for example the children do not reappear, then subsequent video analysis (characterize recorded video step 560 and video processing step 570) can remove this pre-recorded video involving only the animal before the video is transmitted to the remote video communications client 305. In the exemplary intermediate case where the children are peripherally present (audio only), the probability of continuing the video may gradually decrease. However, the reappearance of a child (in time period t₅) would make it preferable to provide a continuous video stream.

Continuing with the example of FIG. 6, a lull in activity occurs which spans portions of the t₅ and t₆ time periods, where video transmission or recording can stop, ending communication event 600. However, an adult (local user 10a) enters the scene during time period 4, and video transmission or recording resumes, potentially starting a new communication event 600. During time period t₇, the adult leaves and, after a time threshold where activity has not been detected, the local video communications client 300 ceases transmitting or recording the video (or optionally returns to transmitting only the occasional still frame).

Then, during time period t₈, potentially problematic content appears in the captured video content, represented in this example by a balloon (object 40) with a smiley face drawn on it. The local video communications client 300 will have to determine whether to transmit or record this content. As video content analysis based on face or eye detection can mistakenly give an affirmative answer to the “person present” determination, other techniques, such as combination analysis or probability analysis can be useful to determine that no people are actually present in the scene. Assuming that the video content analysis properly determines that no people or animals are present, the activity can be classified as “other” and the local video communications client 300 would not transmit or record the video (but could optionally transmit an occasional still frame).

As the above discussion indicates, the determination of the proper video response (transmit, record, or delete) can depend on both the local user and remote user preference settings, as well as the inherent uncertainties present in unscripted live events. The lower portion of FIG. 6 labeled “probability” depicts a probability or confidence value determined by the video analysis component 380 representing the probability of transmitting or recoding video in accordance with the series of exemplary events previously described. Thus, time periods (such as t₁) are depicted where the probability of video capture is low, and other time periods (such as t₃ an t₅) where the probability of video capture is high. There are also time periods (such as t₂, t₄ and t₈) where the probability of video capture is at an intermediate or uncertain value.

In prior discussions, the video communications clients 300, and their image capture devices 120 and video analysis component 380 have been described with respect to an operational process that relies on motion analysis component 382 and video content characterization component 384 to provide supporting functionality for detecting and characterizing user activity in either live or recorded video. While motion detection, activity detection, and activity characterization can use non-video data, including audio collected by microphones 144 or data from other secondary environmental sensors 130, including bio-electric field sensors, the use of video and image data are of particular interest to the present invention. In the case of the detect activity step 510, temporally close or adjacent video frames can be compared to each other to look for differences that are indicative of motion or activity. Comparative image difference analysis, which can use foreground or background segmentation techniques, as well as image correlation and mutual information calculations, can be robust and quick enough to operate in real time. However, image characterization (e.g., detect activity step 510 or characterize recorded video step 560) requires additional techniques or knowledge to distinguish one type of moving object or animate being from another. While the detect activity step 510 occurs in real time, the characterize recorded image step 560 is used to characterize the time shifted pre-recorded video, and analysis time is not as critical in that case. Various methods for characterizing activity from video or still images that can be used by the video communications client 300, include head, face or eye detection analysis, motion analysis, body shape analysis, person-in-box analysis, IR imaging, or combinations thereof.

As described, the video communications clients 300 and 305 utilize semantic data in various ways, including to characterize live (ongoing) or recorded video (for example, in characterize activity step 515 or characterize recorded video step 560), to describe available video content to the local or remote users, and to facilitate privacy management decisions regarding the video content. The video analysis component 380 is principally responsible for analyzing the video content to determine appropriate semantic data associated with the captured activities. This semantic data or metadata can include quantitative metrics from motion analysis that characterize motion or activities of animate or inanimate objects. Data regarding the time, date, and duration of the video captured activity associated with each communication event 600 can also be supplied as semantic metadata, or included in an activity timeline. The semantic data can also describe the activity or associated attributes (including people, animals, identity, or activity type), and include the acceptability rankings (including low interest, mundane content, moderate interest, or high interest) or probability analysis results. Examples of descriptive attributes that can be supplied as semantic data include:
For people, to indicate: adult, child, age, height, gender, ethnicity, clothing) style
For animals, to indicate: species (such as cat or dog), breed, size, coloring
For activities, to indicate: eating, cooking, playing games, laughing, jumping

Certainly, as video analysis component 380 examines images to find people, algorithms that target faces or heads often provide the most immediate value. Facial models key on facial features described by face points, vectors, or templates. Simplified facial models that support fast face detection programs are appropriate for embodiments of the present invention. In practice, many facial detection programs can search quickly for prominent facial features, such as eyes, nose, and mouth, without necessarily relying on body localization searches first. Historically, the first proposed facial recognition model is the “Pentland” model, which is described by M. Turk and A. Pentland in the article “Eigenfaces for Recognition” (Journal of Cognitive Neuroscience, Vol 3, No. 1. 71-86, 1991). The Pentland model is a 2-Dimensional (2D) model intended for assessing direct-on facial images. This model throws out most facial data and keeps data indicative of where the eyes, mouth, and a few other features are. These features are located by texture analysis. This data is distilled down to eigen vectors (direction and extent) related to a set of defined face points (such as eyes, mouth, nose) that model a face. As the Pentland model requires accurate eye locations for normalization, it is sensitive to pose and lighting variations. Also, basic facial models can be prone to false positives, for example identifying clocks or portions of textured wall surfaces as having the sought after facial features. Although the Pentland model works, it has been much improved upon by newer models that address its limitations.

As one such example, the Active Shape Model (ASM), as described by T. F. Cootes, C. J. Taylor, D. Cooper, and J. Graham in the article “Active Shape Models—Their Training and Application”, (Computer Vision and Image Understanding 61, pp. 38-59, January 1995) can be used. A face specific ASM provides a facial model comprising 82 facial feature points. Localized facial features can be described by distances between specific feature points or angles formed by lines connecting sets of specific feature points, or coefficients of projecting the feature points onto principal components that describe the variability in facial appearance. These arc-length features are divided by the inter-ocular distance to normalize across different face sizes. This expanded active shape model is more robust than the Pentland model, as it can handle some variations in lighting, and pose variations ranging out to 15 degrees pose tilt from normal. Other options include active appearance models (AAM) and 3-Dimensional (3D) composite models. Active appearance models, which use texture data, such as for wrinkles, hair, and shadows, are more robust, particularly for identification and recognition tasks. 3D composite models, which utilize 3D geometry to map the face and head, and are particularly useful for variable pose recognition tasks. However, these models are appreciably more computationally intensive than either the Pentland or ASM approaches.

Human faces can also be located in images using direct eye detection methods. As one example, eyes can be located using eye-specific deformable templates, such as suggested in the paper “Feature extraction from faces using deformable templates”, by A. L. Yuille, P. W. Hallinan, and David S. Cohen (International Journal of Computer Vision, Vol. 8, pp. 99-111, 1992). The deformable templates can describe the generalized size, shape, and spacing of the eyes. Another exemplary eye directed template searches images for a shadow-highlight-shadow pattern associated with the eye-nose-eye geometry. However, eye detection alone is often a poor way to search an entire image to reliably locate people or other animate objects. Therefore, eye detection methods can be best used in combination other feature analysis techniques (e.g., body, hair, head, face detection) to validate a preliminary classification that a person or animal is present.

As can be seen, the robustness or speed of locating humans or animals in images can be improved by also analyzing images to locate head or body features. As one example, human faces can be located by searching images for nominally circular skin-toned areas. As an example, the paper “Developing a predictive model of human skin colouring”, by S. D. Cotton (Proc. SPIE, Vol. 2708, pages 814-825, 1996) describes a skin color model that is racially and ethnically insensitive. Using this type of skin color model, images can be analyzed for color data that is common to skin tones for all ethnic groups, thereby reducing statistical confusion from racial, ethnic, or behavioral factors. While this analytical technique can be fast, directional variations in head pose, including poses dominated by hair, can complicate the analysis. Additionally, this technique does not help with animals.

As an example for body shape image analysis, a paper by D. Forsyth et al. “Finding People and Animals by Guided Assembly”, (Proceedings of the Conference on Image Processing, Vol. 3, pp. 5-8, 1997) describes a method for finding people and animals based on body plans or grouping rules for using basic geometric shapes (cylinders) to identify articulating forms. Body images are segmented into a series of interacting geometrical shapes, and the arrangement of these shapes can be correlated with known body plans. Body shape analysis can be augmented by analyzing the movement characteristics, frequency, and direction of the various articulating limbs, to compare to expected types of motion, so as to distinguish heads from other limbs. Body and head shapes of people or animals can also be located in images by using a series of pre-defined body or head shape templates. This technique can also be used in analysis to characterize activities into activity types. In this case, a series of templates can be used to represent a range of common body poses or orientations. Similarly, the video communications client 300 can also differentiate between adults and children using height and age estimation algorithms known in the art.

As another example, IR imaging can be used both for body-shape and facial feature imaging, although the video communications client 300 will require IR sensitive image capture devices 120, if not also IR light sources 135. A paper by Dowdall et al., “Face detection in the near-IR spectrum” (Proc. SPIE, Vol. 5074, pp. 745-756, 2003) describes a face detection system which uses two IR cameras and lower (0.8-1.4 μm) and upper (1.4-2.4 μm) IR bands. Their system employs a skin detection program to localize the image analysis, followed by a feature-based face detection program keyed on eyebrows and eyes. It is important to note that the appearance of humans and animals changes when viewed in near-IR (NIR) light. For example, key human facial features (hair, skin, and eyes, for example) look different (darker or lighter, etc.) than in real life depending on the wavelength band. As an example, in the NIR below 1.4 μm, skin is minimally absorbing, and both transmits and reflects light well, and will tend to look bright compared to other features. The surface texture of the skin images is reduced, giving the skin a porcelain-like quality of appearance. Whereas, above 1.4 μm, skin is highly absorbing and will tend to look dark compared to other features. As another example, some eyes photograph very well in infrared light, while others can be quite haunting. Deep blue eyes, like deep blue skies, tend to be very dark, or even black. IR imaging of furry animals 15, such as cats or dogs, can also vary with the spectral band used. Thus, these imaging differences can aid or confuse body feature detection efforts. IR imaging can readily used to outline a body shape, locate faces or eyes, or aid in understanding confusing visual images. However, IR image interpretation can require additional special knowledge.

As a last example, eyes can sometimes be located very quickly in images if eye visibility is enhanced by “special” circumstances. One example of this is the red eye effect, where human eyes have enhanced visibility when imaged from straight on (or nearly so) during flash photography. As another special case, which does not require flash photography, the eyes of many common animals have increased visibility due to “eye-shine”. Common nocturnally-advantaged animals, such as dogs and cats, have superior low light vision because of an internal highly reflective membrane layer in the back of the eye, called the “tapetum lucidum”. It acts to retro-reflect light from the back of the retina, giving the animal an additional opportunity to absorb and see that light, but also creating eye-shine, where the eyes to appear to glow. While animal eye-shine is more frequently perceived than the red-eye effect in humans, it is also an angularly sensitive effect (only detectable within ˜15 degrees of eye normal). However, due to the high brightness or high contrast of eye-shine eyes relative to the surround, it can be easier and quicker to find eyes exhibiting eye-shine than to search images for the heads or bodies of the animals first.

As these and other image analysis techniques to locate or identify people or animals in images are continually developed or improved, it is not necessary to presently identify the best methods for providing activity detection or image characterization as applied by the video analysis component 380 of the networked video communications system 290 of the present invention. However, there are subtleties concerning the application of such methods to the present invention that merit further consideration. Again, with respect to FIG. 6, during time t₂, a dog (animal 15) was present. Preferably video communications client 300 first detects activity (using detect activity step 510), and then properly determines (using acceptability test 520) whether the animal only activity is considered “acceptable” or not to be transmitted live or recorded based on the results of characterize activity step 515. The lower portion of FIG. 6 depicts the probability for video capture (transmitted or recorded) for the various time periods. In the case of time period t₂, an intermediate probability is illustrated by the solid line. An intermediate result can occur if the video analysis component 380 and video content characterization component 384 are having trouble determining that an animal 15 is present, or that only an animal 15 is present. If, for example, an intermediate result occurs based only on face or head detection image analysis methods, a more time consuming body shape or body motion detection image analysis method may be required. After a more definitive result is obtained, the probability may increase or decrease (dashed lines). The probability can also depend on the acceptability rankings, as animal only content may be considered mundane by the sender (local video communications client 300), but as desired content by the viewer (remote video communications client 305).

The probability or uncertainty of correct video capture can be quantified using confidence values to measure the confidence assigned to the value of an attribute, which can be calculated by computer 340. Confidence values are often expressed as a percentage (0-100%) or a probability (0-1)). In considering the probability graph in FIG. 6, confidence thresholds may be used. Some users 10 may require that only content with high confidence of correct analysis (P>0.85) and high acceptability (ranking of 8 or greater) can be transmitted or recorded by their video communications client 300. Other users may be more tolerant. For example, in the case that confidence values are above a given confidence threshold 450 (for example 0.7), video may be transmitted or recorded as previously described, assuming the content is also considered acceptable, until subsequent video analysis clarifies the content. Whereas, in the case that confidence values are below a required confidence threshold 450 for transmitting or recording video, yet above a lower confidence threshold 460 (for example 0.3) where uncertain content is not to be dumped, video can be buffered or recorded temporarily. After a given period of time, if the confidence value remains in the threshold margin, or drops below that, the buffer or memory can be emptied and video is not transmitted or recorded. It however, the confidence value increases to above the first threshold, the buffered content is transmitted or recorded as needed. Thus, the transmitted or recorded video may contain additional footage surrounding the portions that contain high degree of confidence video that contain lower degree of confidence video. The probability or confidence values that indicate that the video image content is indeed correct or acceptable can be supplied with the video as accompanying metadata.

FIG. 6 also depicts a case where problematic content, represented by an object 40 that is a balloon with a face, is present during time period t₈. In such instances, video analysis component 380 can have particular problem determining that a person is not really present, particularly in real time. Potentially data analysis of data collected from other environmental sensors 130, such as microphones 144 or bio-electric field sensors, can provide clarification, for example by correctly differentiating a relevant animate object (local user 10a or animal 15) from an inanimate object 40. Other image analysis techniques, including ones to identify common confusing objects, such as clock faces, can also provide clarification. However, image analysis can arrive at an unresolved apparent paradox, where a face is detected, although a body is not. In such circumstances, video capture management can again depend upon user preference settings that relate to confidence thresholds 450 and 460 or acceptability rankings.

As discussed previously, acceptability can depend upon a variety of factors, including personal preferences, cultural or religious influences, the type of activity, presence of people or animals, or the time of day, as well as who the recipients are, or whether the content is transmitted live or recorded for time shifted viewing. As an example, the video communications client 300 can also use facial recognition to identify which family members or household guests are present in the captured image. Similarly, video capture can also be identity based.

As another example, users can select the time of day and associated days of the week that content is acceptable to be transmitted or recorded. For example, a user may decide that content is only allowed to be transmitted between the hours of 9 AM and 9 PM on weekdays because outside of this time range they are likely to be not dressed in an appropriate state for remote viewers to see them. Similarly, a user 10 may decide that content on weekends is only viewable between the hours of 11 AM and 11 PM because of changes in activity and sleep patterns on the weekends. Capture time is detected by the video communications client 300 by analyzing the system time provided by the computer 340.

Likewise, users can select to transmit content based on lighting levels. For example, a user may place their video communications client 300 in a dining room and decide that it is only acceptable to transmit or record video when the dining room is lit, either through natural lighting or artificial lighting. This would mean that family meal times are captured or recorded for transmission. Changes in light level could also be used in combination with the time of day. For example, a user could set their preferences to start transmitting or recording video 30 minutes after lights first become illuminated in a day. The point at which lights first become illuminated could be indicative of someone waking up in the morning. Thirty minutes after this point may have given them time to appropriate their appearance in a suitable fashion to be captured or recorded by the video communications system (e.g., combing hair, changing out of pajamas). Changes in light levels such as described in the above examples can be detected with light detectors 140 or image analysis of the captured video images.

In combination with the above described user preferences, the video communications client 300 can use a decision tree algorithm during the acceptability test 520 to decide if the captured video is acceptable for transmission or recording. If the video contains any content that the user has chosen to not be acceptable for transmission or recording, then these system actions are not permitted. On the other hand, if the video only contains content that matches the user's selections of acceptable content to transmit or record, then these system actions are permitted. For example, a user may specify that it is okay to transmit video during the hours of 9 AM to 9 PM which contains only people and not animals. In addition, they may specify that video can only be recorded for time shifting if it occurs between the hours of 5 PM to 9 PM, the time at which they have returned home from work and are performing family activities with their children. Between 9 AM and 9 PM, video is transmitted if it contains only people and not animals. If, however, the remote viewer is not engaged, video is not recorded for later viewing because the conditions do not meet the preferences set by the user for recording. Likewise, users can pre-determine acceptability rankings or confidence thresholds 450 and 460 that can be used during the decision process to handle uncertain content.

It should also be understood that image acceptability can be determined relative to other factors besides user preferences, image analysis characterization robustness, and semantic content definitions. In particular, the acceptability of images for a viewer also can depend on image quality attributes, including image focus, color, and contrast. The video analysis component 380 of video communications client 300 can also include algorithms or programs to actively manage video capture of video scenes 620 relative to such attributes. Similarly, if an image capture device 120 has pan, tilt, and zoom capabilities, image cropping or framing can also be automatically adjusted to improve the viewer experience, even when viewing live unscripted communication events 600. Commonly assigned U.S. patent application Ser. No. 12/408,898, filed Mar. 23, 2009, entitled “Automated Videography Based Communications,” by Kurtz et al., describes a method by which this can be accomplished.

It is also noted that recorded video can also have additional meta-data stored with it that users can read or view to determine if the recorded video is something they wish to actually view and in what way they wish to view it (e.g., passive vs. active viewing). This semantic metadata can be provided by the video analysis component 380 as a result of the characterize recorded video step 560. Certainly, information regarding the activity, participants, time of day, and duration can be provided. Additionally, the metadata can include confidence values obtained by analyzing the video, described previously. This information can then be displayed to the user along with an indication of the time in the video sequence in which confidence values are associated. For example, areas of high confidence may suggest areas of importance that a viewer should watch. Areas of lesser confidence may suggest areas of lesser importance. Activity levels for each frame or group of frames within the video can also be stored as additional meta data that can be visualized along with the recorded video so users can again assess the content prior to or during its viewing. More generally, as suggested by FIG. 6, an activity timeline can be provided, to either the local or remote users, with accompanying semantic metadata that documents the captured video content.

Additionally, it is recognized that the recorded video produced by a video communications client 300 for time shifted viewing can be processed by image processor 320 (during video processing step 570) to change the look or appearance of the recorded video. These changes can include alterations to focus, color, contrast, or image cropping. As one example, the concepts described in U.S. Patent Application Publication No. 2006/0251384 by Vronay et al, or in the paper “Cinematized Reality: Cinematographic 3D Video System for Daily Life Using Multiple Outer/Inner Cameras”, by Kim et al. (IEEE Computer Vision and Pattern Recognition Workshop, 2006) to alter pre-recorded video to lend it a more cinematic appearance can be applied or adapted to the current purpose. For example, Vronay et al. describe an automated video editor (AVE) that is principally used in processing pre-recorded video streams that are collected by one or more cameras to produce video with more professional (and dramatic) visual impact. Each scene is also analyzed by a scene-parsing module to identify objects, people, or other cues that can effect final shot selection. A best-shot selection module applies the shot parsing data, cinematic rules regarding shot selection and shot sequencing, to select the best shots for each portion of a scene. Finally, the AVE constructs a final video and each shot based on the best-shot selections determined for each video stream.

Video communications clients 300 can also simultaneously connect to more than one remote video communications client 305. In these multi-party situations, each video communications client 300 connects directly with each of the other remote video communications clients 305 that are connected across communication networks 360 as a part of the networked video communications system 290. Using user interface controls 190, for each connection, users 10 are able to create specific preferences for what content is acceptable for transmission or recording and what privacy constraints are applied to each transmitted or recorded video stream. For example, if a user 10 connects their local video communications client 300 with four remote video communications clients 305, then the user 10 can set preferences for acceptable content four times, once for each remote video communications client 305, as deemed appropriate. The user can, of course, also set all preferences to be the same for each client. Remote user engagement with the each remote video communications client 305 is assessed on a per client basis. For example, imagine a local video communications client A that is connected to two remote video communications clients, B and C. Video captured at A is deemed acceptable to be transmitted to both B and C. If a user at B is engaged in the video communications system, but users at C are not engaged, then A can transmit content to B, and can record content for later transmission and time-delayed playback to C.

On another note, in the prior discussions, the video communication system 290 has been described as connecting at least two video communications clients (300 and 305) having similar, if not identical capabilities. However, while this configuration is advantageous in many cases, this essentially reciprocal capability is not a requirement. For example, a remote video communications client 305 (remote viewing client) can have an image display 110, but lack an image capture device 120 (on either a temporary or permanent basis). As such, the remote video communications client 305 can receive and display video transmitted from the local video communications client 300, but cannot capture video or still images or activity at the remote environment to be transmitted back to the local video communications client 300. However, data regarding remote viewer status or remote viewing client status can still be collected using non-camera environmental sensors 130 or the user interface 190 at the remote site, and then be supplied back to the video transmitting communications client.

As an additional consideration, it is noted that the Video Probe system, as described in “Video Probe: Sharing Pictures of Everyday Life” by S. Conversy, W. Mackay, M. Beaudouin Lafon, and N. Roussel (Proceedings of the 15^{th} French-Speaking Conference on Human-Computer Interaction, pp. 228-231, 2003) has some commonality with the system of the present invention. The Video Probe consists of a camera and display, which is preferably sitting in a home or mounted to the wall. After the camera detects movement in front of it, if the object or person stays still for three seconds, the camera will capture a still image. The resulting still mages can then be transmitted to connected Video Probe clients where users are able to view them, delete them, or store them for later viewing. The recording features in the present invention are similar to Video Probe's image capture but the present invention either transmits or records video images as a video sequence (as opposed to single images), and in the latter case, the video sequences are post-processed and segmented into appropriate video sequences. The present invention also provides more sophisticated criteria for selecting suitable content, based both on the characteristics of the activity (including people detection, animal detection, or activity type), as well as acceptability criteria, privacy criteria, or other preferences supplied by both the local and remote users. Furthermore, the video communications client 300 of the present invention can determine when to transmit, record, playback or neglect the available video content based on the status of the remote video communications client 305 and remote users 10 (as engaged or disengaged). The Video Probe does not account for the status or preferences regarding availability or acceptability at the receiving clients.

It should also be understood that the programs and algorithms that enable video communications clients 300, and associated video management process 500, can be provided to a hardware system that has the constituent components (including computer 340 and memory 345) to support the functionality of the present invention. Other embodiments that are contemplated by the present invention in which computer readable media and program storage devices tangibly embodying or carrying a program of instructions or algorithms readable by machine or a processor, can provide the enabling instructions or algorithms to hardware system, which can then execute the instructions or data structures stored thereon. Such computer readable media can be any available media that can be accessed by a general purpose or special purpose computer. Such computer-readable media can comprise physical computer-readable media such as RAM, ROM, EEPROM, CD-ROM, DVD, or other optical disk storage, magnetic disk storage or other magnetic storage devices, for example. Any other media that can be used to carry or store software programs which can be accessed by a general purpose or special purpose computer are considered within the scope of the present invention.

The invention has been described in detail with particular reference to certain preferred embodiments thereof, but it will be understood that variations and modifications can be effected within the spirit and scope of the invention. It is emphasized that the apparatus or methods described herein can be embodied in a number of different types of systems, using a wide variety of types of supporting hardware and software. It should also be noted that drawings are not drawn to scale, but are illustrative of key components and principles used in these embodiments.

### PARTS LIST

10 User
10a Local user
10b Remote user
15 Animal
40 Object
100 Electronic imaging device
110 Display
115 Screen
120 image capture device
125 Speaker
130 Environmental sensors
135 IR light source
140 Light detector
142 Motion detector
144 Microphone
146 Housing
160 Split screen image
190 User interface controls
200 Ambient light
290 Networked video communication system
300 Video communications client
305 Remote video communication client
310 Image capture system
315 Audio system
320 Image processor
325 Audio system processor
330 System controller
340 Computer
345 Memory
347 Frame buffer
355 Communications controller
360 Communications network
362 Local site
364 Remote site
380 Video analysis component
382 Motion analysis component
384 Video content characterization component
386 Video segmentation component
390 User privacy controller
415 Local environment
420 image field of view
430 Audio field of view
450 Confidence threshold
460 Lower confidence threshold
500 Video management process
505 Capture video step
510 Detect activity step
515 Characterize activity step
520 Acceptability test
525 Delete video step
526 Delete mundane video step
530 Determine remote status step
535 Remote system on test
540 Remote viewer present test
545 Remote viewer watching lest
550 Transmit live video step
552 Alert remote users step
555 Record video step
557 Record video for local use step
560 Characterize recorded video step
565 Apply privacy constraints step
570 Video processing step
575 Transmit recorded video step
580 Monitor remote status step
585 Offer “in progress” video step
590 Table
600 Communication event
620 Video scene

1. A method for providing video images to a remote viewer using a video communication system, comprising:
operating a video communication system, comprising a video communication client in a local environment connected by a communications network to a remote viewing client in a remote viewing environment, wherein the video communication client includes a video capture device, an image display, and a computer having a video analysis component,
capturing video images of the local environment using the video capture device during a communication event;
analyzing the captured video images with the video analysis component to detect ongoing activity within the local environment;
characterizing the detected activity within the video images with respect to attributes indicative of remote viewer interest;
determining whether acceptable video images are available, responsive to the characterized activity and defined local user permissions;
receiving an indication of whether the remote viewing client is engaged or disengaged; and
transmitting the acceptable video images of the ongoing activity to the remote viewing client if the remote viewing client is engaged, or alternately, if the remote viewing client is disengaged, recording the acceptable video images into a memory and transmitting the recorded video images to the remote viewing client at a later time when an indication is received that the remote viewing client is engaged.

2. The method of claim 1, wherein the video images are not transmitted or recorded, and are deleted from memory when the video images are determined to not be acceptable.

3. The method of claim 1, wherein at least one still image captured by the video capture device is transmitted to the remote viewing client during a portion of a communication event when the video images are determined to not be acceptable.

4. The method of claim 1, wherein an indication that the remote viewing client is engaged is received from the remote viewing client when the remote viewing client is on, a remote viewer is present in the remote viewing environment, and the remote viewer is watching the remote viewing client.

5. The method of claim 1, wherein an indication that the remote viewing client is disengaged is received from the remote viewing client when the remote viewing client is off, or a remote viewer is not present in the remote viewing environment, or the remote viewer is not watching the remote viewing client.

6. The method of claim 1, further including receiving a subsequent indication of the status of the remote viewing client as engaged or disengaged, after the prior indication has been received.

7. The method of claim 6, wherein the behavior of the video communication client, relative to video transmission or video recording, is changed in response to a change in the status of the remote viewing client as engaged or disengaged.

8. The method of claim 1, wherein an indication of the characterized activity or the determined acceptability of the captured video images is provided to the remote viewing client.

9. The method of claim 1, wherein the detected activity is characterized based on quantitative metrics derived from motion analysis.

10. The method of claim 1, wherein the detected activity is characterized based upon semantic attributes, including the presence or identity of people, the presence or identity of animals, the type of activity, or the time of day.

11. The method according to claim 1, wherein the acceptability of the video image content is determined using criteria related to the presence of people, animals, or certain activities in the image content.

12. The method of claim 1, wherein the acceptability of the available video image content is characterized by probability values.

13. The method of claim 12, wherein updated probability values are determined while video images are being captured, and wherein the behavior of the video communication client is changed in response to changes in the probability values.

14. The method of claim 13, wherein the behavior of the video communication client is changed by changing whether the captured video images are being transmitted to the remote viewing client, or recorded for later transmission, or deleted from the memory.

15. The method of claim 1, wherein the acceptability of the video images is characterized by acceptability rankings, including those that classify the content of the video images as unacceptable, mundane, or acceptable.

16. The method of claim 1, wherein the defined local user permissions include limits on what types of video image content can be recorded or transmitted, who is allowed view the video images, how many times recorded video images can be viewed, or how long recorded video can be retained at the remote viewing client.

17. The method of claim 1, wherein the video communication client provides an alert to the remote viewing client that either video images of ongoing activity or recorded video images are available for viewing.

18. The method of claim 1, wherein the recorded video images are characterized relative to various criteria, including the presence or identity of people, the presence or identity of animals, the type of activity, the time of day, or the duration of the recorded video.

19. The method according to claim 1, wherein the detect activity analysis or the video image characterization includes image difference analysis, motion analysis, face detection, eye detection, body shape detection, skin color analysis, or combinations thereof.

20. The method of claim 1, wherein the video communication client and the remote viewing client both provide user interfaces by which remote or local users define their video viewing, transmitting, recording, or privacy preferences.

21. The method of claim 20, wherein an activity timeline is determined for the acceptable video images from one or more video communication events, and the activity timeline is provided on a user interface of either the video communication client or the remote viewing client.

22. The method of claim 1, wherein video images of ongoing activity are recorded in a memory associated with the video communication client.

23. The method of claim 1, wherein the recorded video images are recorded in a memory associated with the remote viewing client.

24. The method of claim 1, wherein the video communication client is connected by a communications network to a plurality of remote viewing clients, and wherein either video images of ongoing activities or recorded video images are transmitted to the remote viewing clients responsive to whether a given remote viewing client is engaged or disengaged.

25. The method of claim 24, wherein local user permissions or remote user preferences can be defined for each remote viewing client.

26. The method of claim 1, wherein the video communication client further includes one or more environmental sensors, wherein one of the environmental sensors is a motion detector, a light detector, an infrared sensitive camera, a bio-electric field detection sensor, a proximity sensor, or a microphone.

27. A method for providing video images to a remote viewer using a video communication system, comprising:
operating a video communication system in a local environment, connected by a communications network to a remote viewing system in a remote viewing environment, wherein the video communication system includes a video capture device, an image display, and a computer having a video analysis component;
capturing video images of the local environment using the video capture device;
analyzing the captured video images using the video analysis component to detect ongoing activity within the local environment;
characterizing the detected activity within the video images with respect to attributes indicative of remote viewer interest;
determining whether acceptable video images are available responsive to the characterized activity and defined local user permissions;
receiving an indication of whether a remote viewer is engaged in viewing the remote viewing system; and
providing the acceptable video image content to the remote viewing system if a remote viewer is engaged in viewing the remote viewing system.

28. A method for providing video images to a remote viewer using a video communication system, comprising:
operating a video communication system in a local environment, connected by a communications network to a remote viewing system in a remote viewing environment, wherein the video communication system includes a video capture device, an image display, a computer having a video analysis component;
capturing video images of the local environment using the video capture device;
analyzing the captured video images using the video analysis component to detect activity within the local environment;
characterizing the detected activity within the video images with respect to attributes indicative of remote viewer interest;
determining whether acceptable video images are available responsive to the characterized activity and defined local user permissions;
receiving an indication of whether a viewer is engaged in viewing the remote viewing system; and
recording the acceptable video images if a viewer is not engaged in viewing the remote viewing system.

29. The method of claim 28, further including transmitting the recorded video images to the remote viewing system at a later time when an indication is received that a viewer is engaged in viewing the remote viewing system.

30. The method of claim 28, wherein remote viewer interest is determined using video images of the remote viewer environment and the remote viewers themselves, which are captured and analyzed by the remote viewing client to determine viewer attributes including identity, activity, attentiveness, or emotional response that are indicative of remote viewer interest.

31. The method of claim 28, wherein remote viewer interest is determined using semantic data regarding the viewers, including calendar data, data describing the relationships of the remote viewers to the local users, or historical data describing viewing behavior or viewing preferences.

32. The method of claim 28, wherein remote viewer interest is prioritized by the remote viewing client relative to the available recorded video images, and the available video images are then offered to remote viewers for viewing based upon the determined prioritized viewer interest.

33. A method for providing video images to a remote viewer using a video communication system, comprising:
operating a video communication system, comprising a video communication client in a local environment, connected by a communications network to a remote viewing client in a remote viewing environment, wherein the video communication client includes a video capture device, an image display, and a computer having a video analysis component,
capturing video images of the local environment using the video capture device during a communication event;
analyzing the captured video images with the video analysis component to detect ongoing activity within the local environment;
characterizing the detected activity within the video images with respect to attributes indicative of remote viewer interest;
determining whether acceptable video images are available, responsive to the characterized activity and defined local user permissions;
determining whether a remote viewer is engaged in viewing the remote viewing client; and
transmitting the acceptable video images of the ongoing activity to the fix remote viewing client if the remote viewer is engaged, or alternately, if the remote viewer is disengaged, recording the acceptable video images into a memory at the local video communication client or a memory at the remote viewing client.

34. The method of claim 33, wherein the local user permissions determine whether the recorded video images are recorded into the memory at the local video communication client or the memory at the remote viewing client.

35. The method of claim 33, wherein the determination of the remote viewer status as engaged or disengaged is completed at either the local video communication client or at the remote viewing client.

36. A video communication system, comprising:
a local video communication client including a video capture device adapted to capture video images of a local environment;
a remote viewing client in a remote viewing environment connected to the local video communication client by a communications network,
a computer for controlling the video communication client; and
a memory system operatively linked to the computer and storing instructions configured to:
cause video images of the local environment to be captured using the video capture device;
analyze the captured video images to detect activity within the local environment;
characterize the detected activity within the video images with respect to attributes indicative of remote viewer interest;
determine whether acceptable video images are available responsive to the characterized activity and defined local user permissions;
receive an indication of whether the remote viewing client is engaged or disengaged; and
provide the acceptable video images to the remote viewing client if the remote viewing client is engaged, or alternately, if the remote viewing client is disengaged, record the acceptable video images into a memory and provide the recorded video images to the remote viewing client at a later time when an indication is received that the remote viewing client is engaged.

37. The system of claim 36 wherein the video communication client further includes one or more environmental sensors, wherein one of the environmental sensors is a motion detector, a light detector, an infrared sensitive camera, a bio-electric field detection sensor, a proximity sensor, or a microphone.

38. The system of claim 36, wherein the video capture device has pan, tilt, or zoom capabilities which are controllable to modify a field of view for the captured video images.
